(19) United States
(12) Patent Application Publication
(10) Pub. No.: US 2012/0205599 A1
(43) Pub. Date: Aug. 16, 2012

(54) COLOR FILTER AND IMAGE DISPLAY APPARATUS HAVING THE SAME

(75) Inventors: Keisuke Matsumoto, Haibara-gun (JP); Akio Katayama, Haibara-gun (JP)

(73) Assignee: FUJIFILM CORPORATION, Minato-ku, Tokyo (JP)

(21) Appl. No.: 13/393,478

(22) PCT Filed: Aug. 4, 2010
(86) PCT No.: PCT/JP2010/063196

§ 371 Date: May 1, 2012

(30) Foreign Application Priority Data
Sep. 4, 2009 (JP) 2009-205203
Jan. 15, 2010 (JP) 2010-007207
May 24, 2010 (JP) 2010-118471

(51) Int. Cl. G02B 5/23

(52) U.S. Cl. 252/586

(57) ABSTRACT

A color filter which has a green colored area that is heat-resistant and has a high luminance, and which is excellent in terms of color reproducibility when applied to an image display apparatus, is provided. An image display apparatus which has the color filter and is excellent in terms of color reproducibility is provided. The color filter has, on a substrate, a green colored area that contains a green pigment or cyan pigment and at least one yellow dye selected from the group consisting of the following (1) to (3):
(1) a methine dye having a pyrazolotriazole ring in a structure thereof;
(2) an azo dye having a pyridone ring in a structure thereof; and
(3) an azo dye having a pyrazole ring in a structure thereof.

### TECHNICAL FIELD

The present invention relates to a color filter and an image display apparatus having the same.

### BACKGROUND ART

In recent years, the use of color filters tends to be increasing not only in liquid crystal display (LCD) elements but also in display elements, such as organic electroluminescent (EL) elements.

Since a color filter is an extremely important member that determines color development of liquid crystal display (LCD) elements, there is an increasing demand for chromaticity, contrast, luminance, and the like, and additional improvement is desired.

In addition to the above, use of color filters to display elements, such as organic EL elements, tends to be increasing as mentioned above. Along with the trend of increasing use of color filters, there is a demand for high color characteristics, such as reduction of color unevenness and improvement in color separation capability, as well as chromaticity, contrast, and the like in color filters, and an increase in fineness is also desired.

In recent years, development of white light-emitting organic EL elements has been actively carried out, and a full color organic EL display obtained by combining the white light-emitting organic EL element and a color filter is known.

There are plural known methods for colorizing organic EL displays, such as a method in which organic EL elements of three colors (RGB) are disposed, or a method in which a blue organic EL element is made to produce three colors of RGB by wavelength conversion. Meanwhile, a method that is industrially available at low costs is a method in which a white organic EL element disposed at each pixel is used as a back light, and light rays are irradiated from the white light source to color filters that have colored areas of three colors of RGB at each pixel, thereby realizing color display (color filter method).

From the above circumstances, there is a demand for color filters that have favorable color characteristics as described above even when used in organic EL displays.

As the white light source used in white light-emitting organic EL elements, a technique in which a blue light-emitting light source and an orange light-emitting light source are used is widely used due to ease of manufacturing, and white light rays are irradiated to a color filter by subtractive color mixing of the blue light and orange light emitted from the light sources.

Here, in the configuration in which white light rays are irradiated from the two color-mixed white light source to the color filter, the intensity of light rays that transmit through the green (G) colored area in the three-color (RGB) colored areas of the color filter tends to become weak compared to the colored areas of the other two colors (R (red) and B (blue)). That is, the transmittance of white light rays is low in the green colored area compared to the colored areas of the other two colors, and, consequently, luminance therein tends to be deteriorated. Therefore, there is a desire for a technique that can increase the luminance of the green colored area in color filters from the viewpoint of color reproducibility when a color filter is applied to display elements.

In order to meet the demand for color reproduction in display apparatuses in which a variety of the above light sources are used, a technique in which dyes and pigments are jointly used in a color filter is described in, for example, Japanese Patent Application Laid-Open (JP-A) No. 5-2106.

In the technique as described in JP-A No. 5-2106, pixels colored by dyes and pixels colored by pigments are laminated. In general, a pixel that is colored with a pigment only has excellent heat resistance and excellent light resistance, but the transmittance of transmitted light rays therein is inferior to a pixel that is colored with a dye only since the transmittance is affected by scattering of pigment particles. The technique as described in JP-A No. 5-2106 is to compensate the defects of pixels in which either dyes or pigments are used singly, but the consequence is merely halving merits and demerits of the use of dyes or pigments singly.

In addition, specifications of JP-A No. 5-119211, JP-A No. 2008-15530, and U.S. Patent Application Publication No. 2008/0171271A1 disclose methods in which a color filter containing a dye and a pigment, which have absorption in the same region, in the same layer thereof, is used. The methods are to improve heat resistance and light resistance, and to improve contrast by reducing the content of pigment particles, but are insufficient in terms of improvement in spectral characteristics as color filters.

Particularly, reduction in luminance that occurs when color reproducibility is improved, which is a problem in the related art, is seldom improved by the above-described method. Accordingly, there is a desire for development of a color filter that is capable of producing sufficient color-reproduced areas when applied to display elements, and causing slight reduction in luminance.

### SUMMARY OF INVENTION

### Technical Problem

A first aspect of the invention has been made in consideration of the above problems, and an object of the first aspect is to provide a color filter that has a green colored area that is heat-resistant and has a high luminance, and is excellent in terms of color reproducibility when applied to an image display apparatus, such as an LCD or a color filter-type organic EL.

In addition, an object of a second aspect of the invention is to provide an image display apparatus that has the color filter and is excellent in terms of color reproducibility.

### Solution to Problem

Specific means of the invention is as follows.

The color filter of the invention has a substrate; and, on the substrate, a green colored area including a green pigment or cyan pigment, and at least one yellow dye selected from the group consisting of the following (1) to (3):

(1) a methine dye having a pyrazolotriazole ring in the structure thereof;

(2) an azo dye having a pyridone ring in the structure thereof;

(3) an azo dye having a pyrazole ring in the structure thereof.

In the color filter of the invention, (1) the methine dye having a pyrazolotriazole ring in the structure thereof is preferably a compound represented by the following formula (Ia) or (Ib).

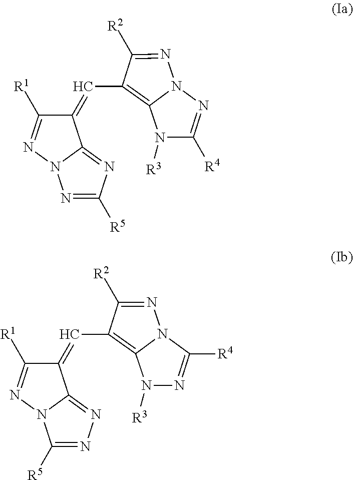

In formulae (Ia) and (Ib), R¹ to R⁵ each independently represent a hydrogen atom or a monovalent substituent.

In the color filter of the invention, (2) the azo dye having a pyridone ring in the structure thereof is preferably a compound represented by the following formula (II).

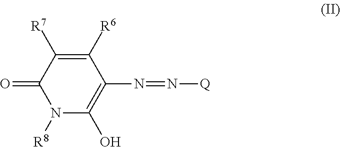

In formula (II), R⁶ and R⁷ each independently represent a hydrogen atom or a monovalent substituent; R⁸ represents a hydrogen atom, an aliphatic group, an aryl group, a heterocyclic group, a carbamoyl group, an aliphatic oxycarbonyl group, an aryloxycarbonyl group, an acyl group, an aliphatic sulfonyl group, an arylsulfonyl group or a sulfamoyl group; and Q represents a diazo component residual. Colorants represented by formula (II) may form a polymer of dimer or higher at arbitrary positions.

Furthermore, in the color filter of the invention, a difference in spectral absorption maximum peak wavelength between the green pigment or cyan pigment and at least one yellow dye selected from the group consisting of the above (1) to (3) in the visible light range is preferably 130 nm or more.

In addition, the difference in spectral absorption maximum peak wavelength between the green pigment or cyan pigment and at least one yellow dye selected from the group consisting of the above (1) to (3) in the visible light range is also preferably 240 nm or less.

The image display apparatus of the invention is an image display apparatus that has the color filter of the invention.

### Advantageous Effects of Invention

According to the invention, a color filter is provided, which has a green colored area that is heat-resistant and has a high luminance, and which is excellent in terms of color reproducibility when applied to an image display apparatus such as an LCD or a color filter-type organic EL.

In addition, an image display apparatus which has the color filter and is excellent in terms of color reproducibility is provided.

### BRIEF DESCRIPTION OF DRAWINGS

FIG. 1 shows spectral absorption spectrums of color filters obtained in test examples.

FIG. 2 shows spectral absorption spectrums of color filters obtained in test examples.

FIG. 3 shows transmission spectrums of color filters obtained in Example A1, Comparative Examples A2 and A3.

### DESCRIPTION OF EMBODIMENTS

Color Filter

Hereinafter, the color filter of the invention will be described in detail.

The color filter of the invention is a color filter that has, on a substrate, a green colored area containing a green pigment or cyan pigment and at least one yellow dye selected from the group consisting of the following (1) to (3):

(1) a methine dye having a pyrazolotriazole ring in the structure thereof;

(2) an azo dye having a pyridone ring in the structure thereof;

(3) an azo dye having a pyrazole ring in the structure.

First, the green colored area in the color filter of the invention will be described in detail.

The green colored area in the color filter of the invention (hereinafter appropriately referred to as the “green area”) includes a green pigment or cyan pigment and at least one yellow dye selected from the group consisting of the above-mentioned (1) to (3) (hereinafter appropriately referred to as the “specific yellow dye”).

The color filter of the invention has a green area that includes a green pigment or cyan pigment and the specific yellow dye. The green area having such a configuration has a high luminance while maintaining heat resistance. This is presumed to be because, when both the specific yellow dye and the pigment included, an association state formed when the dye is used singly is not impaired, and, conversely, solid particles of the pigment are mixed with the association state, thereby forming a stronger association state, and therefore the heat resistance is not deteriorated while high transmittance of transmitted light rays held by the dye is maintained. As a result, it is considered that the color filter has excellent color reproducibility when applied to an image display apparatus.

Hereinafter, the specific yellow dye and the green pigment or cyan pigment used in the invention will be described.

Specific Yellow Dye

### (1) Methine Dye Having Pyrazolotriazole Ring in the Structure Thereof

The methine dye having a pyrazolotriazole ring in the structure thereof in the invention (hereinafter referred to as “pyrazolotriazole methine dye”) is a yellow dye that includes a partial structure in which a pyrazolotriazole ring is directly bonded to a methine group (methine chain).

The pyrazolotriazole methine dye includes one or plural pyrazolotriazole rings in the molecule thereof, and preferably includes a total of two pyrazolotriazole rings with a methine chain therebetween. In addition, it is also a preferable embodiment that the dye has a methine chain formed from an odd number of methine groups. The number of methine groups is preferably one from the viewpoint of the target color reproducibility in the invention.

In particular, the pyrazolotriazole methine dye in the invention is preferably a compound represented by the following formula (Ia) or (Ib), from the viewpoint of attaining both color reproduction and luminance.

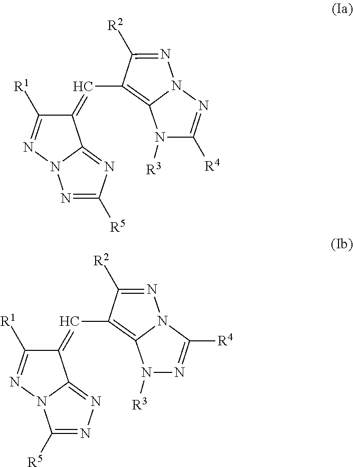

In formulae (Ia) and (Ib), R¹ to R⁵ each independently represent a hydrogen atom or a monovalent substituent.

Here, specific examples of the monovalent substituent represented by R¹ to R⁵ include an alkyl group, an aryl group, a perfluoroalkylcarbonyl group, an alkylsulfonyl group, an alkenylsulfonyl group, an arylsulfonyl group, a heterocyclic sulfonyl group, a sulfamoyl group, an alkylsulfamoyl group, an arylsulfamoyl group, and a heterocyclic sulfamoyl group. Each of the groups may further have a substituent.

Particularly, the compounds represented by formulae (Ia) and (Ib) preferably have the following embodiment: R¹ and R² each independently represent a straight-chain alkyl group or a branched alkyl group; R⁴ and R⁵ each independently represent an alkyl group or an aryl group; and R³ is a hydrogen atom, an alkyl group, or an aryl group.

Hereinafter, specific examples of the pyrazolotriazole methine dye in the invention will be shown, but the invention is not limited thereto.

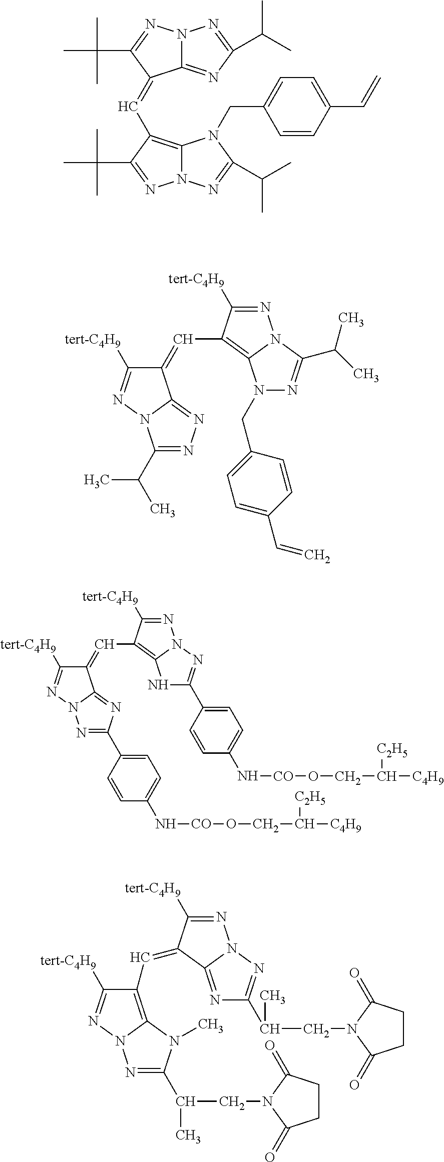

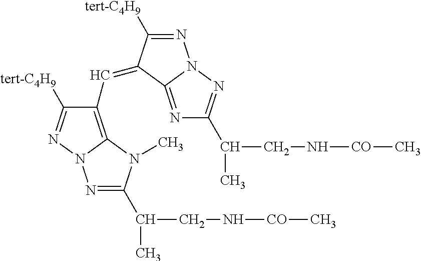

(2) Azo Dye Having Pyridone Ring in the Structure Thereof

The azo dye having a pyridone ring in the structure thereof in the invention (hereinafter referred to as “pyridone azo dye”) is a yellow dye that includes a partial structure in which a pyridone ring is directly bonded to an azo group.

In particular, the pyridone azo dye in the invention is preferably a compound represented by the following formula (II), from the viewpoints of color reproduction and luminance.

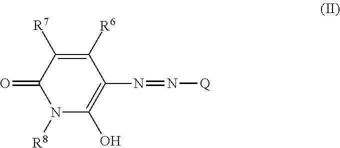

In formula (II), R⁶ and R⁷ each independently represent a hydrogen atom or a monovalent substituent; R⁸ represents a hydrogen atom, an aliphatic group, an aryl group, a heterocyclic group, a carbamoyl group, an aliphatic oxycarbonyl group, an aryloxycarbonyl group, an acyl group, an aliphatic sulfonyl group, an arylsulfonyl group, or a sulfamoyl group; and Q represents a diazo component residue. Colorants represented by formula (II) may form a polymer of dimer or higher at arbitrary positions.

Specific examples of the monovalent substituent represented by R⁶ or R⁷ include a halogen atom, an aliphatic group, an aryl group, a heterocyclic group, a cyano group, a carboxyl group, a carbamoyl group, an aliphatic oxycarbonyl group, an aryloxycarbonyl group, an acyl group, a hydroxyl group, an aliphatic oxy group, an aryloxy group, an aryloxy group, a carbamoyl oxy group, a heterocyclic oxy group, an amino group, an aliphatic amino group, an arylamino group, a heterocyclic amino group, an acyl amino group, a carbamoyl amino group, a sulfamoyl amino group, an aliphatic oxy carbonylamino group, an aryloxycarbonylamino group, an aliphatic sulfonylamino group, an arylsulfonylamino group, a nitro group, an aliphatic thio group, an arylthio group, an aliphatic sulfonyl group, an arylsulfonyl group, a sulfamoyl group, a sulfo group, an imide group, and a heterocyclic thio group. The monovalent substituent represented by R⁶ or R⁷ is preferably an aliphatic group, an aryl group, a heterocyclic group, a cyano group, a carbamoyl group, an aliphatic oxy carbonyl group, an aryloxycarbonyl group, an acyl group, an aliphatic oxy group, an aryloxy group, an aliphatic amino group, or an arylamino group, mainly from the viewpoint of provision of solubility. Each of the groups may be further substituted.

The aliphatic group represented by R⁶ to R⁸ may have a substituent, may be saturated or unsaturated, or may be cyclic. Specific examples thereof include an alkyl group, a substituted alkyl group, an alkenyl group, a substituted alkenyl group, an alkynyl group, a substituted alkynyl group, an aralkyl group, and a substituted aralkyl group. The total number of carbon atoms in the aliphatic group is preferably 1 to 30, and more preferably 1 to 16. Specific examples of the aliphatic group include a methyl group, an ethyl group, a butyl group, an isopropyl group, a t-butyl group, a hydroxyethyl group, a methoxyethyl group, a cyanoethyl group, a trifluoromethyl group, a 3-sulfopropyl group, a 4-sulfobutyl group, a cyclohexyl group, a benzyl group, a 2-phenethyl group, a vinyl group, and an allyl group.

The aryl group represented by R⁶ to R⁸ may have a substituent, is preferably an aryl group that has a total of 6 to 30 carbon atoms, and more preferably an aryl group that has a total of 6 to 16 carbon atoms. Specifically, examples thereof include a phenyl group, a 4-tolyl group, a 4-methoxyphenyl group, a 2-chlorophenyl group, a 3-(3-sulfopropylamino)phenyl group, a 4-sulfamoyl group, a 4-ethoxy ethylsulfamoyl group, and a 3-dimethyl carbamoyl group.

The heterocyclic group represented by R⁶ to R⁸ may be saturated or unsaturated, and includes any one of the following aromatic heterocyclic groups and any one of heteroatoms, such as a nitrogen atom, a sulfur atom, or an oxygen atom, in the ring thereof. The heterocyclic group may further have a substituent, is preferably a heterocyclic group that has a total of 1 to 30 carbon atoms, and more preferably a heterocyclic group that has a total of 1 to 15 carbon atoms. Specific examples include a 2-pyridyl group, a 2-thienyl group, a 2-thiazolyl group, a 2-benzothiazolyl group, a 2-benzoxazolyl group, and a 2-furyl group.

The carbamoyl group represented by R⁶ to R⁸ may have a substituent, is preferably a carbamoyl group that has a total of 1 to 30 carbon atoms, and more preferably a carbamoyl group that has a total of 1 to 16 carbon atoms. Specifically, examples thereof include a methyl carbamoyl group, a dimethyl carbamoyl group, a phenyl carbamoyl group, and an N-methyl-N-phenyl carbamoyl group.

The aliphatic oxycarbonyl group represented by R⁶ to R⁸ may have a substituent, may be saturated or unsaturated, may be cyclic, is preferably an aliphatic oxycarbonyl group that has a total of 2 to 30 carbon atoms, and more preferably an aliphatic oxycarbonyl group that has a total of 2 to 16 carbon atoms. Specifically, examples thereof include a methoxycarbonyl group, an ethoxycarbonyl group, and a 2-methoxy ethoxycarbonyl group.

The aryl oxy carbonyl group represented by R⁶ to R⁸ may have a substituent, is preferably an aryl oxy carbonyl group that has a total of 7 to 30 carbon atoms, and more preferably an aryl oxy carbonyl group that has a carbon atom number of 7 to 16. Specifically, examples thereof include a phenoxy carbonyl group, a 4-methyl phenoxy carbonyl group, a 3-chlorophenoxy carbonyl group, and the like.

Examples of the acyl group represented by R⁶ to R⁸ include an aliphatic carbonyl group, an arylcarbonyl group, and a heterocyclic carbonyl group. The acyl group has a total of 1 to 30 carbon atoms in a preferable embodiment, and has a total of 1 to 16 carbon atoms in a more preferable embodiment. Specific examples thereof include an acetyl group, a methoxyacetyl group, a thienoyl group, and a benzoyl group.

The aliphatic sulfonyl group represented by R⁶ to R⁸ may have a substituent, may be saturated or unsaturated, or may be cyclic. The aliphatic sulfonyl group has a total of 1 to 30 carbon atoms in a preferable embodiment, and has a total of 1 to 16 carbon atoms in a more preferable embodiment. Specific examples thereof include a methane sulfonyl group, a methoxy methane sulfonyl group, and an ethoxy ethane sulfonyl group.

The arylsulfonyl group represented by R⁶ to R⁸ may have a substituent. The arylsulfonyl group has a total of 6 to 30 carbon atoms in a preferable embodiment, and has a total of 6 to 18 carbon atoms in a more preferable embodiment. Specific examples thereof include a benzene sulfonyl group and a toluene sulfonyl group.

The sulfamoyl group represented by R⁶ to R⁸ may have a substituent. The sulfamoyl group has a total of 0 to 30 carbon atoms in a preferable embodiment, and has a total of 0 to 16 carbon atoms in a more preferable embodiment. Specific examples thereof include a sulfamoyl group, a dimethylsulfamoyl group, and a di-(2-hydroxyethyl)sulfamoyl group.

The imide group represented by R⁶ or R⁷ may have a substituent, and is preferably a 5- to 6-membered cyclic imide group. In addition, the total number of carbon atoms in the imide group is preferably 4 to 30 in a preferable embodiment, and more preferably 4 to 20 in a more preferable embodiment. Specific examples thereof include a succinimide group and a phthalic imide group.

The diazo component residue represented by Q refers to a residue of a diazo component “A-NH₂”. Particularly, Q is preferably an aryl group or an aromatic heterocyclic group, from the viewpoint of the target color reproducibility.

Here, the aromatic heterocyclic group is an aromatic ring that includes any one of hetero atoms, such as a nitrogen atom, a sulfur atom, or an oxygen atom, in the ring thereof, and is preferably a 5- to 6-membered aromatic heterocyclic ring. The number of carbon atoms in the aromatic heterocyclic group is preferably 1 to 25, and more preferably 1 to 15. Specific examples of the aromatic heterocyclic ring include a pyrazole group, a 1,2,4-triazole group, an isothiazole group, a benzoisothiazole group, a thiazole group, a benzothiazole group, an oxazole group, and a 1,2,4-thiadiazole group.

Particularly, the compound represented by formula (II) preferably has the following embodiment: that is, R⁶ is a cyano group, an aliphatic oxycarbonyl group, or a carbamoyl group; R⁷ is an aliphatic group; R⁸ is an aliphatic group, an acyl group, an aryl group, an aliphatic carbonyl group, an aliphatic sulfonyl group, or an arylsulfonyl group; and Q is an aryl group.

Hereinafter, specific examples of the pyridone azo dye in the invention will be shown, but the invention is not limited thereto.

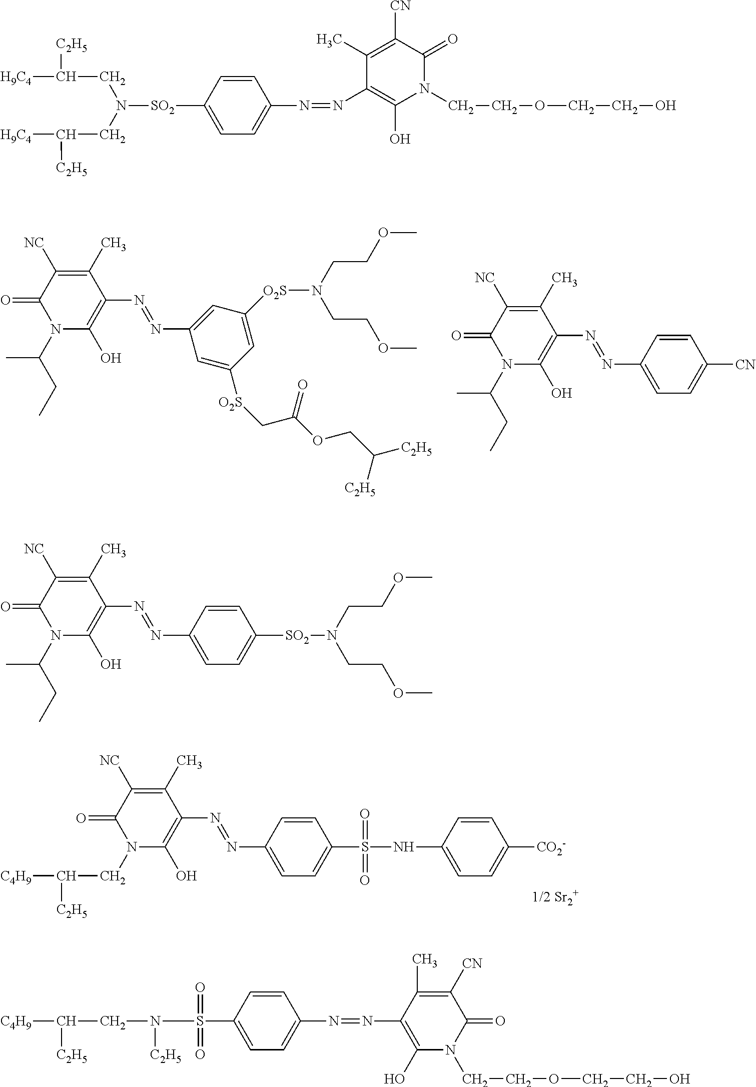

(3) Azo Dye Having Pyrazole Ring in the Structure Thereof

The azo dye having a pyrazole ring in the structure thereof in the invention (hereinafter referred to as “pyrazole azo dye”) is a yellow dye that includes a partial structure in which a pyrazole ring is directly bonded to an azo group.

The pyrazole azo dye preferably has a pyrazole group and, as a diazo component residue bonded thereto via an azo group (that is, a residue of a diazo component “A-NH₂”), an aryl group or aromatic heterocyclic group, from the viewpoints of color reproduction and luminance.

Hereinafter, specific examples of the pyrazole azo dye in the invention will be shown, but the invention is not limited thereto.

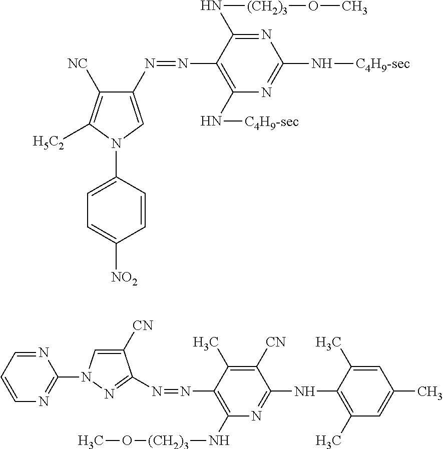

Green Pigment or Cyan Pigment

In the invention, the specific yellow dye mentioned above coexists with a green pigment or cyan pigment in a green area.

Well-known pigments (for example, green pigments or cyan pigments that are listed in the ‘other pigments’ section described below) may be used as the green pigment or cyan pigment that is used in the invention, but a phthalocyanine-based pigment is preferable from the standpoint of heat resistance.

Specific examples of the green pigment or cyan pigment used in the invention include C.I. Pigment Green 7, 36, 58; C.I. Pigment Blue 15:3, and aluminum phthalocyanine pigment. However, the green pigment or cyan pigment is not limited to the above in the invention.

Meanwhile, as the aluminum phthalocyanine pigment, the aluminum phthalocyanine pigment as described in JP-A No. 2004-333817 is preferably used.

Preferable Combinations and Mixing Ratios

In the invention, it is preferable that the combinations of the green pigment or cyan pigment and the specific yellow dye preferably satisfy the following conditions.

That is, it is preferable to use a combination capable of attaining the difference in spectral absorption maximum peak wavelength between the green pigment or cyan pigment and the specific yellow dye in the visible light range of 130 nm or more, more preferably 140 nm or more, and still more preferably 150 nm or more. When the difference is less than 130 nm, there are cases in which it is difficult to increase the luminance.

In addition, it is preferable to use a combination capable of attaining the difference in spectral absorption maximum peak wavelength between the green pigment or cyan pigment and the specific yellow dye in the visible light range of 240 nm or less, and more preferably 220 nm or less. When the difference exceeds 240 nm, there are cases in which it is difficult to secure a sufficient color-reproduced area when the color filter is applied to an image display apparatus.

In the invention, it is most preferable to use a combination in which the difference in spectral absorption maximum peak wavelength between the green pigment or cyan pigment and the specific yellow dye in the visible light range is from 150 nm to 240 nm.

Here, the spectral absorption maximum peak wavelength of a pigment or dye is measured as described below.

Specifically, as described below in Examples, a monochromatic color filter produced using the pigment or dye singly, and a spectral absorption spectrum for the color filter is measured using a MCPD-2000 (manufactured by Otsuka Electronics Co., Ltd.).

In addition, in the green area of the invention, the proportion (mass proportion) of the specific yellow dye with respect to the green pigment or cyan pigment varies depending on selected compounds, but is preferably from 5% to 300%, and more preferably from 20% to 300%.

The content of the green pigment or cyan pigment in the green area of the invention is preferably from 1% by mass to 50% by mass, more preferably from 10% by mass to 45% by mass, and still more preferably from 15% by mass to 40% by mass, from the viewpoints of color reproducibility and luminance.

Other Dyes and Pigments

The green area of the invention may contain other dyes and/or pigments in addition to the green pigment or cyan pigment and the specific yellow dye, as long as the effects of the invention are not impaired.

When other dyes and/or pigments are used in the green area of the invention, the total proportion of the green pigment or cyan pigment and the specific yellow dye included in the green area is preferably from 60% by mass to 100% by mass, and more preferably to from 80% by mass to 100% by mass, with respect to the total content of the pigment(s) and dye(s) included in the green area.

Other Dyes

Other dyes which may be used in the invention are not particularly limited, and may be selected from well-known solvent-soluble dyes and the like.

Examples thereof include colorants as described in JP-A No. 64-90403, JP-A No. 64-91102, JP-A No. 1-94301, JP-A No. 6-11614, Japanese Patent No. 2592207, U.S. Pat. No. 4,808,501, U.S. Pat. No. 5,667,920, U.S. Pat. No. 5,059,500, JP-A No. 5-333207, JP-A No. 6-35183, JP-A No. 6-51115, JP-A No. 6-194828, and the like.

Regarding chemical structures, azo-based dyes such as anilino azo dyes, aryl azo dyes, or pyrazolotriazole azo dyes, triphenylmethane dyes, anthraquinone dyes, anthrapyridone dyes, benzylidene dyes, oxonol dyes, cyanine dyes, phenothiazine dyes, pyrrolopyrazole azomethine dyes, xanthene dyes, phthalocyanine dyes, benzopyran dyes, indigo dyes, or the like may be used.

Other Pigments

As other pigments used in the invention, a variety of well-known inorganic pigments or organic pigments may be used.

Since it is preferable that the pigment used in the invention has a high transmittance regardless of whether the pigment is an inorganic pigment or an organic pigment, it is preferable to use a pigment having a particle diameter as small as possible and a fine particle size. The average particle diameter is preferably from 0.01 μm to 0.3 μm, and more preferably from 0.01 μm to 0.15 μm, from the viewpoint of handling properties. When the particle diameter is in the above ranges, it is effective for forming a color filter having a high transmittance, favorable color characteristics, and a high contrast. Meanwhile, the preferable particle diameter values are also applicable to the green pigment or cyan pigment.

Examples of the inorganic pigment include metallic compounds represented by metallic oxides, metallic complex salts, and the like. Specific examples include metallic oxides of iron, cobalt, aluminum, cadmium, lead, copper, titanium, magnesium, chromium, zinc, antimony, or the like, and complex oxides of these metals.

Examples of the organic pigment include:

C.I. Pigment Red 1, 2, 3, 4, 5, 6, 7, 9, 10, 14, 17, 22, 23, 31, 38, 41, 48:1, 48:2, 48:3, 48:4, 49, 49:1, 49:2, 52:1, 52:2, 53:1, 57:1, 60:1, 63:1, 66, 67, 81:1, 81:2, 81:3, 83, 88, 90, 105, 112, 119, 122, 123, 144, 146, 149, 150, 155, 166, 168, 169, 170, 171, 172, 175, 176, 177, 178, 179, 184, 185, 187, 188, 190, 200, 202, 206, 207, 208, 209, 210, 216, 220, 224, 226, 242, 246, 254, 255, 264, 270, 272, 279;

C.I. Pigment Yellow 1, 2, 3, 4, 5, 6, 10, 11, 12, 13, 14, 15, 16, 17, 18, 20, 24, 31, 32, 34, 35, 35:1, 36, 36:1, 37, 37:1, 40, 42, 43, 53, 55, 60, 61, 62, 63, 65, 73, 74, 77, 81, 83, 86, 93, 94, 95, 97, 98, 100, 101, 104, 106, 108, 109, 110, 113, 114, 115, 116, 117, 118, 119, 120, 123, 125, 126, 127, 128, 129, 137, 138, 139, 147, 148, 150, 151, 152, 153, 154, 155, 156, 161, 162, 164, 166, 167, 168, 169, 170, 171, 172, 173, 174, 175, 176, 177, 179, 180, 181, 182, 185, 187, 188, 193, 194, 199, 213, 214;

C.I. Pigment Orange 2, 5, 13, 16, 17:1, 31, 34, 36, 38, 43, 46, 48, 49, 51, 52, 55, 59, 60, 61, 62, 64, 71, 73;

C.I. Pigment Green 10, 37;

C.I. Pigment Blue 1, 2, 15, 15:1, 15:2, 15:4, 15:6, 16, 22, 60, 64, 66, 79, C.I. Pigment Blue 79 in which the Cl substituent thereof is replaced with OH, 80;

C.I. Pigment Violet 1, 19, 23, 27, 32, 37, 42;

C.I. Pigment Brown 25, 28;

C.I. Pigment Black 1, 7, and the like.

Pigments that are used in the invention (green pigment, cyan pigment, and other pigments) may be made into fine particles, if necessary.

For producing the fine particles of the organic pigment, it is preferable to use a method that includes a process of grinding a highly viscous liquid composition obtained from the organic pigment, a water-soluble organic solvent, and a water-soluble inorganic salt.

In the invention, it is more preferable to use the following method for producing fine particles of the organic pigment.

That is, first, a mixture (liquid composition) of the organic pigment, a water-soluble organic solvent, and water-soluble inorganic salts is treated with a strong shear force using a twin roll, a triple roll, a ball mill, a trommel, a disper (DISPER), a kneader, a co-kneader, a homogenizer, a blender, a uniaxial or biaxial extruder, or the like, thereby grinding the organic pigments in the mixture. Then, the mixture is injected in water and made into a slurry using a stirrer or the like. Next, the slurry is filtered and washed with water, to remove the water-soluble organic solvent and the water-soluble inorganic salts, and the slurry is then dried, thereby producing fine particles of organic pigment.

Examples of the water-soluble organic solvent used for the fine particle production method include methanol, ethanol, isopropanol, n-propanol, isobutanol, n-butanol, ethylene glycol, diethylene glycol, diethylene glycol monomethyl ether, diethylene glycol monoethyl ether, diethylene glycol monobutyl ether, propylene glycol, and propylene glycol monomethyl ether acetate.

In addition, benzene, toluene, xylene, ethyl benzene, chlorobenzene, nitrobenzene, aniline, pyridine, quinoline, tetrahydrofuran, dioxane, ethyl acetate, isopropyl acetate, butyl acetate, hexane, heptane, octane, nonane, decane, undecane, dodecane, cyclohexane, methyl cyclohexane, halogenated hydrocarbon, acetone, methyl ethyl ketone, methyl isobutyl ketone, cyclohexanone, dimethylformamide, dimethyl sulfoxide, N-methyl pyrrolidone, and the like may be used as long as they are used at a small amount so as to be absorbed in the pigments and not washed out in wastewater. In addition, a mixture of two or more solvents may be used according to necessity.

The amount of the water-soluble organic solvent to be used is preferably in a range of from 50% by mass to 300% by mass, and more preferably in a range of from 100% by mass to 200% by mass, with respect to the organic pigments.

In addition, as the water-soluble inorganic salt used in the invention, sodium chloride, potassium chloride, calcium chloride, barium chloride, sodium sulfate, or the like may be used.

The amount of the water-soluble inorganic salt to be used is preferably one time to 50 times the mass of the organic pigment, and more preferably one time to 10 times the mass of the organic pigment, from the standpoint of productivity while the grinding effect becomes stronger at a larger amount.

In addition, it is preferable that the moisture content in the liquid composition to be ground is preferably 1% by mass or less, for preventing dissolution of the water-soluble inorganic salt.

In the invention, a wet pulverization apparatus such as the above-mentioned kneader may be used for grinding the liquid composition including the organic pigment, the water-soluble organic solvent, and the water-soluble inorganic salt. The operation conditions of the wet pulverization apparatus are not particularly limited; however, in order to effectively perform the grinding using a pulverization medium (water-soluble inorganic salt), the operation conditions when a kneader is used as the apparatus are such that a rotation number of a blade in the apparatus is preferably 10 rpm to 200 rpm, and the rotation ratio of two axes is relatively large since the grinding effect is large. In addition, the operation time is preferably from 1 hour to 8 hours in conjunction with the dry pulverization time, and the inside temperature of the apparatus is preferably from 50° C. to 150° C. In addition, the water-soluble inorganic salt, which is a pulverization medium, preferably has a pulverized particle size distribution of from 5 μm to 50 μm, has a sharp particle diameter distribution, and a spherical shape.

The mixture after the grinding in the above manner is mixed with warm water of 80° C. so that the water-soluble organic pigment and the water-soluble inorganic salt are dissolved, followed by filteration, washing with water, and drying in an oven, whereby fine organic pigments may be obtained.

Pigment Dispersion Composition

For forming the green area in the invention, it is preferable to prepare and use a pigment dispersion composition that contains a green pigment or a cyan pigment (and other pigments according to necessity).

The pigment dispersion composition is obtained by dispersing the pigment together with a dispersant or a pigment derivative in a solvent.

The dispersant used herein is used to improve the dispersibility of the pigment, and, for example, a well-known pigment dispersant or surfactant may be appropriately selected and used.

Dispersant

Specifically, a large variety of compounds may be used as the dispersant, and examples thereof include cationic surfactants such as an organosiloxane polymer KP341 (manufactured by Shin-Etsu Chemical Co., Ltd.), a (meth)acrylic acid (co)polymer POLYFLOW No. 75, No. 90, No. 95 (manufactured by Kyoeisha Chemical Co., Ltd.), or W001 (manufactured by Yusho Co., Ltd.); nonionic surfactants such as polyoxy ethylene lauryl ether, polyoxyethylene stearyl ether, polyoxyethylene oleyl ether, polyoxyethylene octylphenyl ether, polyoxyethylene nonyl phenyl ether, polyethylene glycol dilaurate, polyethylene glycol distearate, or sorbitan aliphatic acid ester; anionic surfactants such as W004, W005 and W017 (manufactured by Yusho Co., Ltd.); polymer dispersants such as EFKA-46, EFKA-47, EFKA-47EA, EFKA POLYMER 100, EFKA POLYMER 400, EFKA POLYMER 401, EFKA POLYMER 450 (all manufactured by Ciba Specialty Chemicals K.K. Japan), DISPERSE AID 6, DISPERSE AID 8, DISPERSE AID 15, or DISPERSE AID 9100 (all manufactured by San Nopco Ltd.); a variety of SOLSPERSE dispersants such as SOLSPERSE 3000, 5000, 9000, 12000, 13240, 13940, 17000, 24000, 26000, or 280000 (manufactured by Lubrizol Japan Limited); ADEKA PLURONIC L31, F38, L42, L44, L61, L64, F68, L72, P95, F77, P84, F87, P94, L101, P103, F108, L121, P-123 (manufactured by ADEKA Corporation), IONET S-20 (manufactured by Sanyo Chemical Industries, Ltd.), and DISPERBYK-101, -103, -106, -108, -109, -111, -112, -116, -130, -140, -142, -161, -162, -163, -164, -166, -167, -170, -171, -174, -176, -180, -182, -2000, -2001, -2050, or -2150 (manufactured by BYK Japan K.K.). Examples thereof also include oligomers or polymers having a polar group at a molecular terminal or side chain thereof, such as acrylic copolymers.

The amount of the dispersant to be used is preferably from 0.5 parts by mass to 100 parts by mass, and more preferably from 3 parts by mass to 70 parts by mass, with respect to the total amount of the pigment(s) included in the pigment dispersion composition. When the amount of the dispersant is in the above ranges, a sufficient pigment-dispersing effect is obtained. It should be noted that even when more than 100 parts by mass of the dispersant is added, there are cases in which an effect of further improving the pigment-dispersing effect cannot be expected.

Pigment Derivative

In addition, a pigment derivative is added to the pigment dispersion composition according to necessity.

In the invention, a pigment derivative having a moiety that has an affinity to the dispersant or having a polar group introduced thereto, is absorbed at the pigment surface, and the pigment derivative is used as an absorption point of the dispersant, whereby the pigment is capable of being dispersed in the pigment dispersion composition as fine particles, and prevented from reaggregation thereof. In summary, the pigment derivative modifies the pigment surface, thereby producing an effect of promoting absorption of the dispersant.

The pigment derivative used in the invention is, specifically, a compound that has an organic pigment as a mother skeleton, and an acidic group, a basic group, or an aromatic group introduced to a side chain as a substituent. Specific examples of the organic pigment that serves as the mother skeleton include a quinacridone pigment, a phthalocyanine pigment, an azo pigment, a quinophthalone pigment, an isoindoline pigment, an isoindolinone pigment, a quinoline pigment, a diketopyrrolopyrrole pigment, and a benzimidazolone pigment. The examples further include pale yellow, aromatic polycyclic compounds such as naphthalene compounds, anthraquinone compounds, triazine compounds, or quinoline compounds, which are not generally regarded as colorants.

Pigment derivatives as described in JP-A No. 11-49974, JP-A No. 11-189732, JP-A No. 10-245501, JP-A No. 2006-265528, JP-A No. 8-295810, JP-A No. 11-199796, JP-A No. 2005-234478, JP-A No. 2003-240938, JP-A No. 2001-356210, and the like may be used as the pigment derivative.

The content of the pigment derivative according to the invention in the pigment dispersion composition is preferably from 1% by mass to 30% by mass, and more preferably from 3% by mass to 20% by mass, with respect to the mass of the pigment. When the content is in the above ranges, dispersing may be favorably carried out, and the dispersion stability after the dispersing may be improved while the viscosity is suppressed at a low level, and high transmittance and excellent color characteristics may be obtained. Therefore, it is possible to achieve a high contrast with favorable color characteristics when a color filter is produced.

Solvent

Examples of the solvent used for the pigment dispersion composition include the same solvents as those used for a photocurable composition as described below.

The concentration of the pigment in the pigment dispersion composition is preferably from 30% by mass to 90% by mass, and more preferably from 40% by mass to 80% by mass.

The pigment dispersion composition may be prepared by performing a mixing and dispersing process in which the pigment is mixed and dispersed using a variety of mixers and dispersers.

The mixing and dispersing process is preferably composed of kneading and dispersing, and a subsequent fine dispersion treatment, but the kneading and dispersion may not be omitted.

Specifically, for example, the pigment and, if necessary, a dispersant, are mixed in advance, and, furthermore, the pigment that is dispersed in advance using a homogenizer or the like is finely dispersed using a bead disperser in which zirconia beads or the like are used (for example, DISPERMET, manufactured by Getzmann GmbH) or the like, whereby the pigment dispersion composition may be prepared.

The dispersion time is preferably from approximately 3 hours to 6 hours.

In addition, for the fine dispersion treatment using beads, mainly, a vertical type or horizontal type sand grinder, a pin mill, a slit mill, an ultrasonic disperser, or the like, and beads made of glass that has a particle diameter of from 0.01 mm to 1 mm, zirconia, or the like may be used.

The details of the kneading and dispersing are described in “Paint Flow and Pigment Dispersion”, by T. C. Patton (1964, published by John Wiley and Sons, Inc.) and the like.

Photocurable Composition

The green area of the invention is preferably formed using a photocurable composition that includes the pigment dispersion composition.

The content (pigment concentration) of the pigment in the photocurable composition is preferably 30% by mass to 60% by mass, more preferably 35% by mass to 60% by mass, and still more preferably 40% by mass to 60% by mass, with respect to the total solid content of the photocurable composition.

When the concentration of the pigment is in the above ranges, color concentration is sufficient, and it is effective to secure excellent color characteristics.

Meanwhile, in a case in which the pigment derivative is used in the pigment dispersion composition, a value obtained by dividing the total mass of the pigment and the pigment derivative by the total solid content of the photocurable composition is used as the pigment concentration of the photocurable composition.

The photocurable composition used in the invention preferably contains an alkali-soluble resin, a compound having an ethylenic unsaturated double bond in the molecule thereof, a photo-polymerization initiator, a solvent, and the like, in addition to the pigment dispersion composition.

Hereinafter, the respective components of the photocurable composition will be described.

Alkali-Soluble Resin

The photocurable composition used in the invention preferably contains an alkali-soluble resin.

The alkali-soluble resin may be appropriately selected from alkali-soluble resins which are linear organic high-molecular-weight polymers, and have at least one group that accelerates alkali solubility (for example, a carboxyl group, a phosphoric acid group, a sulfonic acid group, or the like) in the molecule (preferably, a molecule having an acrylic copolymer or a styrene copolymer as the main chain) thereof. Among them, alkali-soluble resins which are soluble in an organic solvent, and enable development with a weak alkali aqueous solution are further preferable.

For manufacturing of the alkali-soluble resin, for example, a well-known radical polymerization method may be applied. Polymerization conditions, such as temperature, pressure, the type and amount of radical initiator, the type of solvent, and the like when the alkali-soluble resin is manufactured by the radical polymerization method may be easily set by a person skilled in the art, or it is also possible to experimentally specify the conditions.

The linear organic high-molecular-weight polymer is preferably a polymer having a carboxylic acid at the side chain. Examples thereof include methacrylic acid copolymers, acrylic acid copolymers, itaconic acid copolymers, chrotonic acid copolymers, maleic acid copolymers, partially esterified maleic acid copolymers, acidic cellulose derivatives that have a carboxylic acid at the side chain, polymers that have a hydroxyl group to which an acid anhydride is added, and the like, which are described in JP-A No. 59-44615, Japanese Examined Patent Application Publication (JP-B) No. 54-34327, JP-B No. 58-12577, JP-B No. 54-25957, JP-A No. 59-53836, and JP-A No. 59-71048. The high-molecular-weight polymers further having a (meth)acryloyl group at the side chain are also preferable.

In particular, multicomponent copolymers such as benzyl(meth)acrylate/(meth)acrylic acid copolymers or benzyl(meth)acrylate/(meth)acrylic acid/other monomers are preferable.

Additionally, copolymers of 2-hydroxyethyl methacrylate are also useful. The above copolymers may be mixed in arbitrary amounts and then used.

In addition to the above, examples thereof include 2-hydroxypropyl(meth)acrylate/polystyrene macromomomer/benzyl methacrylate/methacrylic acid copolymers, 2-hydroxy-3-phenoxy propyl acrylate/polymethyl methacrylate macromonomer/benzyl methacrylate/methacrylic acid copolymers, 2-hydroxyethyl methacrylate/polystyrene macromonomer/methyl methacrylate/methacrylic acid copolymers, 2-hydroxyethyl methacrylate/polystyrene macromonomer/benzyl methacrylate/methacrylic acid copolymers, and the like, which are described in JP-A No. 7-140654.

Regarding the specific constituent unit of the alkali-soluble resin, it is particularly preferable to use a copolymer of a (meth)acrylic acid and other monomer(s) which is copolymerizable with the (meth)acrylic acid.

Examples of the other monomer which is copolymerizable with (meth)acrylic acid include alkyl(meth)acrylates, aryl(meth)acrylates, and vinyl compounds. Here, the hydrogen atoms in an alkyl group and an aryl group may be substituted with a substituent.

Specific examples of the alkyl(meth)acrylates and aryl(meth)acrylates include methyl(meth)acrylate, ethyl(meth)acrylate, propyl(meth)acrylate, butyl(meth)acrylate, isobutyl(meth)acrylate, pentyl(meth)acrylate, hexyl(meth)acrylate, octyl(meth)acrylate, phenyl(meth)acrylate, benzyl acrylate, tolyl acrylate, naphthyl acrylate, and cyclohexyl acrylate.

In addition, examples of the vinyl compounds include styrene, α-methyl styrene, vinyl toluene, glycidyl methacrylate, acrylonitrile, vinyl acetate, N-vinyl pyrrolidone, tetrahydrofurfuryl methacrylate, polystyrene macromonomers, polymethyl methacrylate macromonomers, CH₂═CR¹R², and CH²═C(R¹)(COOR³)[in which, R¹ represents a hydrogen atom or an alkyl group having 1 to 5 carbon atoms, R² represents an aromatic hydrocarbon ring having 6 to 10 carbon atoms, and R³ represents an alkyl group having 1 to 8 carbon atoms or an aralkyl group having 6 to 12 carbon atoms].

The other monomers which are copolymerizable may be used singly or in combination of two or more kinds thereof. The other monomers which are copolymerizable are preferably at least one selected from CH₂═CR¹R², CH₂═C(R¹)(COOR³), phenyl(meth)acrylate, benzyl(meth)acrylate, and styrene, and particularly preferably CH₂═CR¹R² and/or CH₂═C(R¹)(COOR³).

The content of the alkali-soluble resin, which is a binder polymer, in the photocurable composition is preferably from 1% by mass to 15% by mass, more preferably from 2% by mass to 12% by mass, and particularly preferably from 3% by mass to 10% by mass, with respect to the total solid content of the composition.

Polymerizable Compound Having Ethylenic Unsaturated Bond in the Molecule Thereof

The photocurable composition used in the invention preferably contains a polymerizable compound having an ethylenic unsaturated bond in the molecule thereof (hereinafter simply referred to as “polymerizable compound”).

Examples of the polymerizable compound in the invention include polymerizable monomers and oligomers that have at least one ethylenic unsaturated double bond, and compounds which have at least one ethylenic unsaturated double bond and have a boiling point at normal pressure of 100° C. or higher are particularly preferable.

Examples of the compounds which have at least one ethylenic unsaturated double bond and a boiling point at normal pressure of 100° C. or higher include monofunctional acrylates and methacrylates, such as polyethylene glycol mono(meth)acrylate, polypropylene glycol mono(meth)acrylate, or phenoxyethyl(meth)acrylate; and polyfunctional acrylates and methacrylates, such as polyethylene glycol di(meth)acrylate, trimethylolethane tri(meth)acrylate, neopentyl glycol di(meth)acrylate, pentaerythritol tri(meth)acrylate, pentaerythritol tetra(meth)acrylate, dipentaerythritol hexa(meth)acrylate, hexanediol(meth)acrylate, trimethylolpropane tri(acryloyloxypropyl)ether, tri(acryloyloxyethyl)isocyanurate, (meth)acrylates obtained by adding an ethylene oxide or propylene oxide to a polyfunctional alcohol such as glycerin or trimethylol ethane, poly(meth)acrylates of pentaerythritol or dipentaerythritol, urethane acrylates as described in JP-B No. 48-41708, JP-B No. 50-6034, and JP-A No. 51-37193, polyester acrylates as described in JP-A No. 48-64183, JP-B No. 49-43191, and JP-B No. 52-30490, and epoxy acrylates that are reaction products of an epoxy resin and a (meth)acrylic acid.

Also, photocurable monomers and oligomers as described in Journal of the Adhesion Society of Japan, Vol. 20, No. 7, pages 300 to 308 may be used.

In addition, the compounds obtained by adding an ethylene oxide or propylene oxide to a polyfunctional alcohol, followed by (meth)acrylization thereof, which are described as formulae (1) and (2) in JP-A No. 10-62986, and which are described together with the specific examples thereof, may also be used.

Among them, dipentaerythritol penta(meth)acrylate, dipentaerythritol hexa(meth)acrylate, and a structure in which acryloyl groups thereof are linked via an ethylene glycol or propylene glycol residue are preferable. Oligomers thereof may also be used.

The polymerizable compound of the invention may be used singly, or may be used in combination of two or more kinds thereof.

The content of the polymerizable compound in the photocurable composition is preferably from 2% by mass to 30% by mass, more preferably from 3% by mass to 25% by mass, and particularly preferably from 5% by mass to 20% by mass, with respect to the total solid content of the composition. When the content of the polymerizable compound is in the above ranges, a curing reaction is sufficiently carried out.

Photopolymerization Initiator

The photocurable composition used in the invention preferably contains a photopolymerization initiator.

Examples of the photopolymerization initiator include active halogen compounds such as halomethyloxadiazoles as described in JP-A No. 57-6096 or halomethyl-s-triazines as described in JP-B No. 59-1281, JP-B No. 53-133428, and the like; ketals, acetals, and aromatic carbonyl compounds such as benzoin alkyl ether, which are described in U.S. Pat. No. 4318791, European Patent No. 88050A, and the like; aromatic ketone compounds such as benzophenones, which are described in U.S. Pat. No. 4,199,420; compounds of (thio)xanthones or acridines as described in French Patent No. 2456741; compounds of coumarins or lophione dimers of JP-A No. 10-62986; and sulfonium organoboron complexes as described in JP-A No. 8-015521.

In the invention, the photopolymerization initiator is preferably an acetophenone compound, a ketal compound, a benzophenone compound, a benzoin compound, a benzoyl compound, a xanthone compound, a triadine compound, a halomethyloxadiazole compound, an acridine compound, a coumarin compound, a biimidazole compound, an oxime ester compound, or the like.

Preferable examples of the acetophenone photopolymerization initiator include 2,2-diethoxy acetophenone, p-dimethyl amino acetophenone, 2-hydroxy-2-methyl-1-phenyl-propan-1-on, p-dimethylamino acetophenone, and 4′-isopropyl-2-hydroxy-2-methyl-propiophenone.

Preferable examples of the ketal photopolymerization initiator include benzyl dimethyl ketal and benzyl-β-methoxy ethyl acetal.

Preferable examples of the benzophenone photopolymerization initiator include benzophenone, 4,4′-(bisdimethylamino)benzophenone, 4,4′-(bisdiethylamino)benzophenone, 4,4′-dichlorobenzophenone, 1-hydroxy-cyclohexyl-phenyl-ketone, 2-benzyl-2-dimethylamino-1-(4-morpholinophenyl)-butanone-1, 2-tolyl-2-dimethylamino-1-(4-morpholinophenyl)-butanone-1, and 2-methyl-1-[4-(methylthio)phenyl]-2-morpholinopropanone-1.

Preferable examples of the benzoin or benzoyl photopolymerization initiator include benzoin isopropyl ether, benzoin isobutyl ether, benzoin methyl ether, and methyl o-benzoyl benzoate.

Preferable examples of the xanthone photopolymerization initiator include diethyl thioxanthone, diisopropyl thioxanthone, monoisopropyl thioxanthone, and chlorothioxanthone.

Preferable examples of the triazine photopolymerization initiator include 2,4-bis(trichloromethyl)-6-p-methoxyphenyl-s-triazine, 2,4-bis(trichloromethyl)-6-p-methoxy styryl-s-triazine, 2,4-bis(trichloromethyl)-6-(1-p-dimethylaminophenyl)-1,3-butadienyl-s-triazine, 2,4-bis(trichloromethyl)-6-biphenyl-s-triazine, 2,4-bis(trichloromethyl)-6-(p-methylbiphenyl)-s-triazine, p-hydroxyethyoxystyryl-2,6-di(trichloromethyl)-s-triazine, methoxystyryl-2,6-di(trichloromethyl)-s-triazine, 3,4-dimethoxystyryl-2,6-di(trichloromethyl)-s-triazine, 4-benzoxilane-2,6-di(trichloromethyl)-s-triazine, 4-(o-bromo-p-N,N-(diethyoxycarbonylamino)-phenyl)-2,6-di(chloromethyl)-s-triazine, and 4-(p-N,N-(diethyoxycarbonylamino)-phenyl)-2,6-di(chloromethyl)-s-triazine.

Preferable examples of the halomethyloxadiazole photopolymerization initiator include 2-trichloromethyl-5-styryl-1,3,4-oxadiazole, 2-trichloromethyl-5-(cyanostyryl)-1,3,4-oxadiazole, 2-trichloromethyl-5-(naphtho-1-yl)-1,3,4-oxadiazole, and 2-trichloromethyl-5-(4-styryl)styryl-1,3,4-oxadiazole.

Preferable examples of the acridine photopolymerization initiator include 9-phenylacridine and 1,7-bis(9-acridinyl)heptane.

Preferable examples of the coumarin photopolymerization initiator include 3-methyl-5-amino-((s-triazin-2-yl)amino)-3-phenylcoumarin, 3-chloro-5-diethylamino-((s-triazin-2-yl)amino)-3-phenylcoumarin, and 3-butyl-5-dimethylamino-((s-triazin-2-yl)amino)-3-phenylcoumain.

Preferable examples of the biimidazole photopolymerization initiator include 2-(o-chlorophenyl)-4,5-diphenylimidazolyl dimer, 2-(o-methoxyphenyl)-4,5-diphenylimidazolyl dimer, and 2-(2,4-dimethoxyphenyl)-4,5-diphenylimidazolyl dimer.

In addition to the above, examples of the photopolymerization initiator in the invention include 1-phenyl-1,2-propanedione-2-(o-ethoxycarbonyl)oxime, o-benzoyl-4′-(benzomercapto)benzoyl-hexyl-ketoxime, 2,4,6-trimethylphenylcarbonyl-diphenyl phosphonyl oxide, and hexafluorophosphoro-trialkylphenyl phosphonium salt.

In the invention, the photopolymerization initiator is not limited to the above photopolymerization initiators, and other well-known photopolymerization initiators may be used. Examples thereof include vicinal polyketol aldonil compounds as described in U.S. Pat. No. 2,367,660, α-carbonyl compounds as described in U.S. Pat. No. 2,367,661 and U.S. Pat. No. 2,367,670, acyloin ethers as described in U.S. Pat. No. 2,448,828, α-hydrocarbon-substituted aromatic acyloin compounds as described in U.S. Pat. No. 2,722,512, polynuclear quinone compounds as described in U.S. Pat. No. 3,046,127 and U.S. Pat. No. 2,951,758, combinations of triaryl imidazole dimers and p-aminophenyl ketone as described in U.S. Pat. No. 3,549,367, combinations of benzothiazole compounds and trihalomethyl-s-triazine compounds as described in JP-B No. 51-48516, and oxime ester compounds as described in J. C. S. Perkin II (1979) 1653 to 1660, J. C. S. Perkin II (1979) 156 to 162, Journal of Photopolymer Science and Technology (1995) 202 to 232, and JP-A No. 2000-66385.

In addition, according to purpose, plural kinds of the photopolymerization initiators may be jointly used.

The content of the photopolymerization initiator in the photocurable composition is preferably from 0.1% by mass to 15.0% by mass, more preferably from 0.3% by mass to 10.0% by mass, and particularly preferably from 0.5% by mass to 8.0% by mass, with respect to the total solid content of the composition. When the content of the photopolymerization initiator is in the ranges, a polymerization reaction favorably proceeds, and a film having excellent strength is formed.

Solvent

In general, the photocurable composition used in the invention may be preferably prepared using a solvent, together with the above components.

Examples of the solvent include esters such as ethyl acetate, n-butyl acetate, isobutyl acetate, amyl formate, isoamyl acetate, isobutyl acetate, butyl propionate, isopropyl acetate, ethyl acetate, butyl acetate, alkyl esters, methyl lactate, ethyl lactate, methyl oxyacetate, ethyl oxyacetate, butyl oxyacetate, methyl methoxy acetate, ethyl methoxy acetate, butyl methoxy acetate, methyl ethoxy acetate, or ethyl ethoxy acetate; 3-oxypropionic acid alkly esters such as 3-oxypropionic acid methyl esters or 3-oxypropionic acid ethyl esters, methyl 3-methoxypropionate, ethyl 3-methoxypropionate, methyl 3-ethoxypropionate, ethyl 3-ethoxypropionate, methyl 2-oxypropionate, ethyl 2-oxypropionate, propyl 2-oxypropionate, methyl 2-methoxypropionate, ethyl 2-methoxypropionate, propyl 2-methoxypropionate, methyl 2-ethoxypropionate, ethyl 2-ethoxypropionate, methyl 2-oxy-2-methylpropionate, ethyl 2-oxy-2-methylpropionate, methyl 2-methoxy-2-methylpropionate, ethyl 2-ethoxy-2-methylpropionate, metyl pyruvate, ethyl pyruvate, propyl pyruvate, methyl acetoacetate, ethyl acetoacetate, methyl 2-oxobutanoate, ethyl 2-oxobutanoate; ethers such as diethylene glycol dimethyl ether, tetrahydrofuran, ethylene glycol monomethyl ether, ethylene glycol monoethyl ether, methyl cellosolve acetate, ethyl cellosolve acetate, diethylene glycol monomethyl ether, diethylene glycol monoethyl ether, diethylene glycol monobutyl ether, propylene glycol methyl ether acetate, propylene glycol ethyl ether acetate, or propylene glycol propyl ether acetate; ketones such as methyl ethyl ketone, cyclohexanone, 2-heptanone, or 3-heptanone; and aromatic hydrocarbons such as toluene or xylene.

Among them, methyl 3-ethoxypropionate, ethyl 3-ethoxypropionate, ethyl cellosolve acetate, ethyl lactate, diethylene glycol dimethyl ether, butyl acetate, methyl 3-methoxypropionate, 2-heptanone, cyclohexanone, ethyl carbitol acetate, butyl carbitol acetate, propylene glycol methyl ether acetate, and the like are preferable.

The solvent may be used singly, or may be used in combination of two or more kinds thereof.

Other Components

The photocurable composition used in the invention may contain, according to necessity, a variety of additives such as a sensitizing colorant, a hydrogen-donating compound, a fluorine-containing organic compound, a thermal polymerization initiator, a thermal polymerization component, or a thermal polymerization inhibitor, as well as a filler, a high molecular compound other than the above-mentioned alkali-soluble resin (binder polymer), a surfactant, an adhesion promoter, an oxidation inhibitor, an ultraviolet absorbent, or an aggregation inhibitor.

Sensitizing Colorant

A sensitizing colorant may be added to the photocurable composition used in the invention, if necessary. When the sensitizing colorant is exposed to light having a wavelength absorbable by the sensitizing colorant, the sensitizing colorant is capable of promoting the radical generation reaction of the photopolymerization initiator, or the resulting polymerization reaction of the photopolymerization compound.

The sensitizing colorant includes well-known spectral sensitizing colorants or dyes, or dyes or pigments that absorb light rays and interact with a photopolymerization initiator.

Spectral Sensitizing Colorants or Dyes

Examples of spectral sensitizing colorants or dyes, which are preferable sensitizing colorants used in the invention, include polynuclear aromatics (for example, pyrene, perylene, and triphenylene), xanthenes (for example, fluorescein, eosin, erythrosine, rhodamine B, and rose bengal), cyanines (for example, thiacarbocyanine and oxacarbocyanine), merocyanines (for example, merocyanine and carbomerocyanine), thiazines (for example, thionine, methylene blue, and toluidine blue), acridines (for example, acridine orange, chloroflavin, and acriflavine), phthalocyanines (for example, phthalocyanine and metal phthalocyanine), porphyrins (for example, tetraphenylporphyrin, and center metal-substituted prophyrin), chlorophylls (for example, chlorophyll, chlorophyllin, and center metal-substituted chlorophyll), metal complexes (for example, the compound shown below), anthraquinones (for example, anthraquinone), and squaryliums (for example, squarylium).

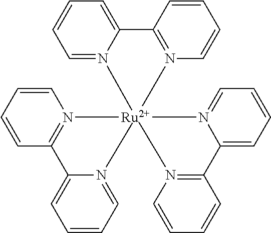

Examples of more preferable spectral sensitizing colorants or dyes will be shown below.

Examples include styryl-based colorants as described in JP-B No. 37-13034; cation dyes as described in JP-A No. 62-143044; quinoxalinium salts as described in JP-B No. 59-24147; novel methylene blue compounds as described in JP-A No. 64-33104; anthraquinones as described in JP-A No. 64-56767; benzoxanthene dyes as described in JP-A No. 2-1714; acridines as described in JP-A No. 2-226148 and JP-A No. 2-226149; pyrylium salts as described in JP-B No. 40-28499; cyanines as described in JP-B No. 46-42363; benzofuran colorants as described in JP-A No. 2-63053; conjugated ketone colorants as described in JP-A No. 2-85858 and JP-A 2-216154; colorants as described in JP-A No. 57-10605; azo cinnamylidene derivatives as described in JP-B No. 2-30321; cyanine-based colorants as described in JP-A No. 1-287105; xanthene-based colorants as described in JP-A No. 62-31844, JP-A No. 62-31848, and JP-A No. 62-143043; amino styryl ketones as described in JP-B No. 59-28325; colorants as described in JP-A No. 2-179643; merocyanine colorants as described in JP-A No. 2-244050; merocyanine colorants as described in JP-B No. 59-28326; merocyanine colorants as described in JP-A No. 59-89303; merocyanine colorants as described in JP-A No. 8-129257; and benzopyran-based colorants as described in JP-A No. 8-334897.

Colorants Having Maximum Absorption Wavelength in 350 nm to 450 nm

Other preferable embodiments of the sensitizing colorant include colorants that belong to the following compound group and have the maximum absorption wavelength within 350 nm to 450 nm.

Examples of more preferable sensitizing colorant include the compounds represented by the following formulae (XIV) to (XVIII).

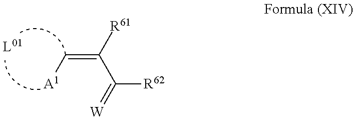

In formula (XIV), A¹ represents a sulfur atom or —N(R⁶⁰)—, in which R⁶⁰ represents an alkyl group or an aryl group; L⁰¹ represents a non-metallic atomic group that forms a basic nucleus of a colorant in conjunction with the adjacent A¹ and carbon atom; R⁶¹ and R⁶² each independently represent a hydrogen atom or a monovalent non-metallic atomic group; R⁶¹ and R⁶² may bond to each other so as to form an acidic nucleus of a colorant; and W represents an oxygen atom or a sulfur atom.

Hereinafter, preferable specific examples [(F-1) to (F-5)] of compounds represented by formula (XIV) will be shown.

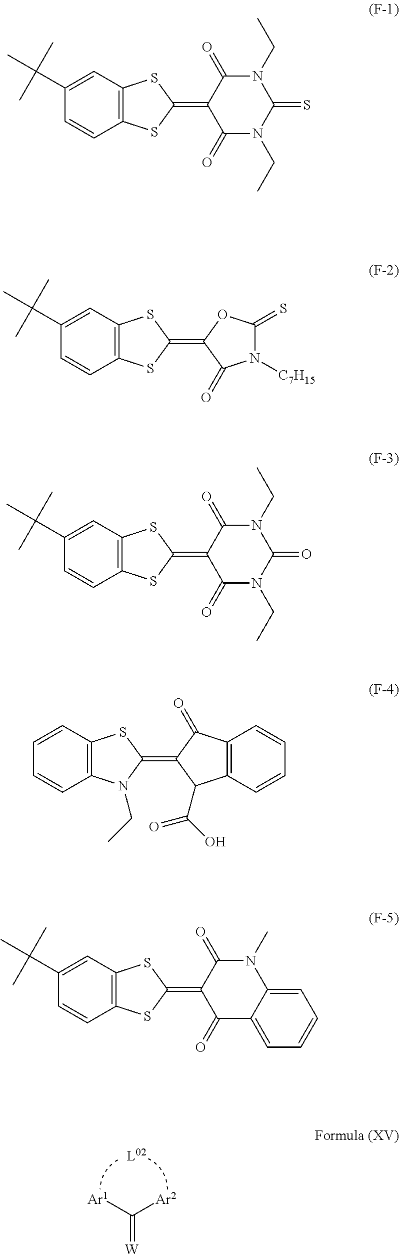

In formula (XV), Ar¹ and Ar² each independently represent an aryl group, and are bonded via a bond or -L⁰²-, in which -L⁰²- represents —O— or —S—; and W has the same definition as defined in formula (XIV).

Preferable examples of compounds represented by the general formula (XV) include the following compounds [(F-6) to (F-8)].

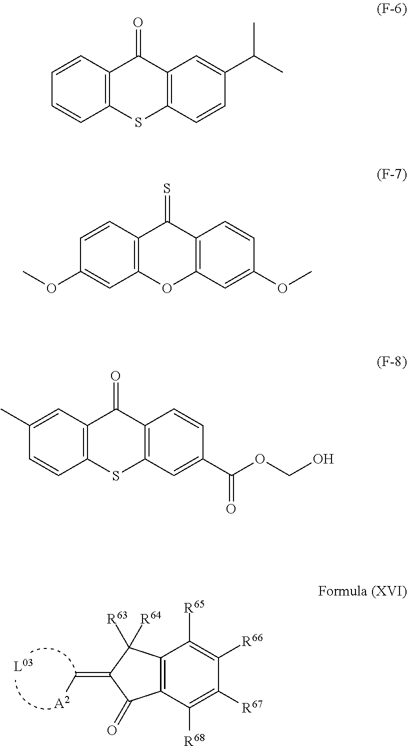

In formula (XVI), A² represents a sulfur atom or —N(R⁶⁹)—; L³ represents a non-metallic atomic group that forms a basic nucleus of a colorant in conjunction with the adjacent A² and carbon atom; R⁶³, R⁶⁴, R⁶⁵, R⁶⁶, R⁶⁷, and R⁶⁸ each in dependently represent a group of a monovalent non-metallic atomic group; and R⁶⁹ represents an alkyl group or an aryl group.

Preferable examples of compounds represented by the general formula (XVI) include the following compounds [(F-9) to (F-11)].

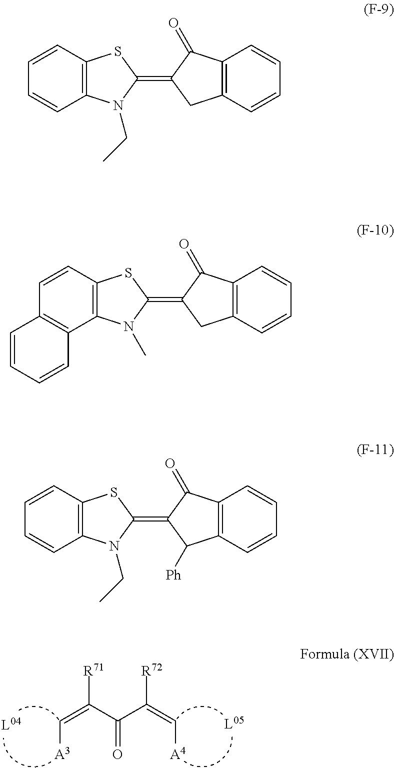

In formula (XVII), A³ and A⁴ each independently represent —S— or —N(R⁷³)—, in which R⁷³ represents a substituted or unsubstituted alkyl group or a substituted or unsubstituted aryl group; L⁰⁴ and L⁰⁵ each independently represent a non-metallic atomic group that forms a basic nucleus of a colorant in conjunction with the adjacent A³ or A⁴, and carbon atom; R⁷¹ and R⁷² each independently represent a monovalent non-metallic atomic group, and may be bonded to each other so as to form an aliphatic or aromatic ring.

Preferable examples of compounds represented by formula (XVII) include the following compounds [(F-12) to (F-15)].

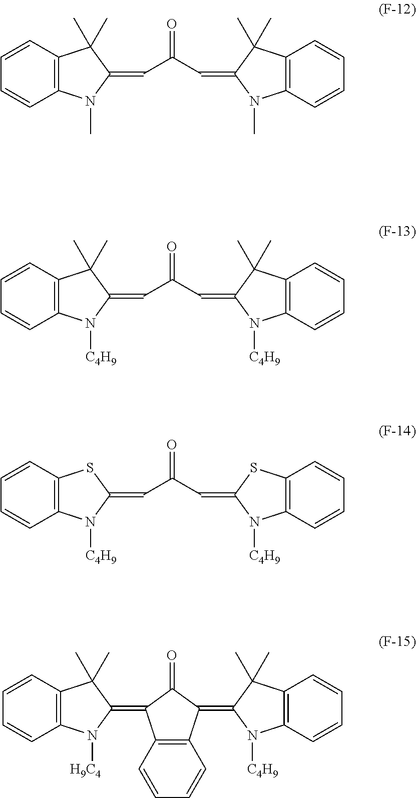

In addition, examples of preferable sensitizing colorants used in the invention include compounds represented by the following formula (XVIII).

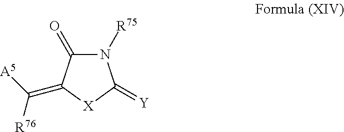

In formula (XVIII), A⁵ represents an aromatic ring which may have a substituent or a hetero ring which may have a substituent; X represents an oxygen atom, a sulfur atom, or —N(R⁷⁴)—; Y represents an oxygen atom, a sulfur atom, or ═N(R⁷⁴); R⁷⁴, R⁷⁵, and R⁷⁶ each independently represent a hydrogen atom or a monovalent non-metallic atomic group; A⁵ and R⁷⁴ may bind to each other so as to form an aliphatic or aromatic ring; and R⁷⁵ and R⁷⁶ may bind to each other so as to form an aliphatic or aromatic ring.

Here, when R⁷⁴, R⁷⁵, and R⁷⁶ each represent a monovalent non-metallic atomic group, R⁷⁴, R⁷⁵, and R⁷⁶ preferably each represent a substituted or unsubstituted alkyl group or a substituted or unsubstituted aryl group.

Next, preferable examples of R⁷⁴, R⁷⁵, and R⁷⁶ will be described specifically. Examples of preferable alkyl group include straight, branched, and cyclic alkyl groups having 1 to 20 carbon atoms. Specific examples thereof include a methyl group, an ethyl group, a propyl group, a butyl group, a pentyl group, a hexyl group, a heptyl group, an octyl group, a nonyl group, a decyl group, an undecyl group, a dodecyl group, a tridecyl group, a hexadecyl group, an octadecyl group, an eicosyl group, an isopropyl group, an isobutyl group, an s-butyl group, a t-butyl group, an isopentyl group, a neopentyl group, a 1-methylbutyl group, an isohexyl group, a 2-ethylhexyl group, a 2-methylhexyl group, a cyclohexyl group, a cyclopentyl group, and a 2-norbornyl group. Among them, straight alkyl groups having 1 to 12 carbon atoms, branched alky groups having 3 to 12 carbon atoms, and cyclic alkyl groups having 5 to 10 carbon atoms are more preferable.

As the substituent for the substituted alkyl group, a monovalent non-metallic atomic group, other than a hydrogen atom, is used. Preferable examples thereof include a halogen atom (—F, —Br, —Cl, and —I), a hydroxyl group, an alkoxy group, an aryloxy group, a mercapto group, an alkylthio group, an arylthio group, an alkyldithio group, an aryldithio group, an amino group, an N-alkylamino group, an N,N-dialkylamino group, an N-arylamino group, an N,N-diarylamino group, an N-alkyl-N-arylamino group, an acyloxy group, a carbamoyloxy group, an N-alkyl carbamoyloxy group, an N-aryl carbamoyloxy group, an N,N-dialkyl carbamoyloxy group, an N,N-diaryl carbamoyloxy group, an N-alkyl-N-aryl carbamoyloxy group, an alkylsulfoxy group, an arylsulfoxy group, an acyloxy group, an acyl thio group, an acyl amino group, an N-alkyl acyl amino group, an N-aryl acyl amino group, an ureido group, an N-alkyl ureido group, an N,N-dialkyl ureido group, an N-aryl ureido group an N,N-diaryl ureido group, an N-alkyl-N-aryl ureido group, an N-alkyl ureido group, an N-aryl ureido group, an N-alkyl-N-alkyl ureido group, an N-alkyl-N-aryl ureido group, an N,N-dialkyl-N-alkyl ureido group, an N,N-dialkyl-N-aryl ureido group, an N-aryl-N-alkyl ureido group, an N-aryl-N-aryl ureido group, an N,N-diaryl-N-alkyl ureido group, an N,N-diaryl-N-aryl ureido group, an N-alkyl-N-aryl-N-alkyl ureido group, an N-alkyl-N-aryl-N-aryl ureido group, an alkoxy carbonyl amino group, an aryloxycarbonyl amino group, an N-alkyl-N-alkoxycarbonyl amino group, an N-alkyl-N-aryloxycarbonyl amino group, an N-aryl-N-alkoxycarbonyl amino group, an N-aryl-N-aryloxycarbonyl amino group, a formyl group, an acyl group, a carboxyl group, an alkoxy carbonyl group, an aryloxycarbonyl group, a carbamoyl group, an N-alkyl carbamoyl group, an N,N-dialkyl carbamoyl group, an N-aryl carbamoyl group, an N,N-diaryl carbamoyl group, an N-alkyl-N-aryl carbamoyl group, an alkyl sulfinyl group, an aryl sulfinyl group, an alkyl sulfonyl group, an aryl sulfonyl group, a sulfo group (—SO₃H) and its conjugated basic group (hereinafter referred to as the sulfonate group), an alkoxy sulfonyl group, an aryloxy sulfonyl group, a sulfinamoyl group, an N-alkyl sulfinamoyl group, an N,N-dialkyl sulfinamoyl group, an N-aryl sulfinamoyl group, an N,N-diaryl sulfinamoyl group, an N-alkyl-N-aryl sulfinamoyl group, a sulfamoyl group, an N-alkyl sulfamoyl group, an N,N-dialkyl sulfamoyl group, an N-aryl sulfamoyl group, an N,N-diaryl sulfamoyl group, an N-alkyl-N-aryl sulfamoyl group, a phosphono group (—PO₃H₂) and its conjugated basic group (hereinafter referred to as the phosphonate group), a dialkyl phosphono group (—PO₃(alkyl)₂), a diaryl phosphono group (—PO₃(aryl)₂), an alkyl aryl phosphono group (—PO₃(alkyl)(aryl)), a monoalkyl phosphono group (—PO₃H(alkyl)) and its conjugated basic group (hereinafter referred to as the alkyl phosphonate group), a monoaryl phosphoxy group (—POH₃(aryl)) and its conjugated basic group (hereinafter referred to as the arylphosphoate group), a phosphonoxy group (—OPO₃H₂) and its conjugated basic group (hereinafter referred to as the phosphonatoxy group), a dialkyl phosphonoxy group (—OPO₃(alkyl)₂), a diaryl phosphonoxy group (—OPO₃(aryl)₂), an alkyl aryl phosphonoxy group (—OPO₃(alkyl)(aryl)), a monoalkyl phosphonoxy group (—OPO₃H(alkyl)) and its conjugated basic group (hereinafter referred to as the alkyl phosphonatoxy group), a monoaryl phosphonoxy group (—OPO₃H(aryl)) and its conjugated basic group (hereinafter referred to as the aryl phosphonatoxy group), a cyano group, a nitro group, an aryl group, a heteroaryl group, an alkenyl group, an alkynyl group, and a silyl group.

Specific examples of the alkyl group in the above substituents include the above-mentioned alkyl group, and the alkyl group may further have a substituent.

In addition, specific examples of the aryl group include a phenyl group, a biphenyl group, a naphthyl group, a tolyl group, a xylyl group, a mesityl group, a cumenyl group, a chlorophenyl group, a bromophenyl group, a chloromethyl phenyl group, a hydroxy phenyl group, a methoxy phenyl group, an ethoxy phenyl group, a phenoxy phenyl group, an acetoxy phenyl group, a benzoyloxy phenyl group, a methylthio phenyl group, a phenylthio phenyl group, a methylamino phenyl group, a dimethylamino phenyl group, an acetylamino phenyl group, a carboxyphenyl group, a methoxycarbonyl phenyl group, an ethoxyphenylcarbonyl group, a phenoxycarbonyl phenyl group, an N-phenylcarbamoyl phenyl group, a phenyl group, a cyanophenyl group, a sulfophenyl group, a sulfonate phenyl group, a phosphonophenyl group, and a phosphonatophenyl group.

As the heteroaryl group, a group derived from a monocyclic or polycyclic aromatic ring having at least one of a nitrogen atom, an oxygen atom, and a sulfur atom is used. In particular, preferable examples of heteroaryl ring in the heteroaryl group include thiophene, thianthrene, furan, pyran, isobenzofuran, chromene, xanthene, phenoxazine, pyrrole, pyrazole, isothiazole, isooxazole, pyrazine, pyrimidine, pyridazine, indolizine, isoindolizine, indole, indazole, purine, quinolizine, isoquinoline, phthalazine, naphthyridine, quinazoline, cinnoline, pteridine, carbazole, carboline, phenanthrene, acridine, perimidine, phenanthroline, phthalazine, phenarsazine, phenoxazine, furazen, and phenoxazine. They may have a benzo-condensed ring, or have a substituent.

In addition, examples of the alkenyl group include a vinyl group, a 1-prophenyl group, a 1-butenyl group, a cinnamyl group, and a 2-chloro-1-ethenyl group. Examples of the alkynyl group include an ethynyl group, a 1-propyl group, a 1-butynyl group, and a trimethylsilylethynyl group. G¹ in the acyl group (G¹CO—) includes hydrogen, and the alkyl group and the aryl group mentioned above. Among the substituents, more preferable substituents include a halogen atom (—F, —Br, —Cl, and —I), an alkoxy group, an aryloxy group, an alkylthio group, an arylthio group, an N-alkylamino group, an N,N-dialkylamino group, an acyloxy group, an N-alkyl carbamoyloxy group, an N-aryl carbamoyloxy group, an acyl amino group, a formyl group, an acyl group, a carboxyl group, an alkoxy carbonyl group, an aryloxycarbonyl group, a carbamoyl group, an N-alkyl carbamoyl group, an N,N-dialkyl carbamoyl group, an N-aryl carbamoyl group, an N-alkyl-N-aryl carbamoyl group, a sulfo group, a sulfonate group, a sulfamoyl group, an N-alkyl sulfamoyl group, an N,N-dialkyl sulfamoyl group, an N-aryl sulfamoyl group, an N-alkyl-N-aryl sulfamoyl group, a phosphono group, a phosphonate group, a dialkyl phosphono group, a diaryl phosphono group, a monoalkyl phosphono group, an alkyl phosphonate group, a monoaryl phosphono group, an aryl phosphonato group, a phosphonoxy group, a phosphonatoxy group, an aryl group, an alkenyl group, an alkylidene group (methylene group, and the like), and the like.

Meanwhile, the alkylene group in the substituted alkyl group includes divalent organic residues obtained by removing any one of hydrogen atoms in the above-mentioned alkyl group having 1 to 20 carbon atoms, and preferably includes straight alkylene groups having 1 to 12 carbon atoms, branched alkylene groups having 3 to 12 carbon atoms, and cyclic alkylene groups having. 5 to 10 carbon atoms.

Specific examples of substituted alkyl group preferable as R⁷⁴, R⁷⁵, or R⁷⁶ that is obtained by combining the substituent and an alkylene group include a chloromethyl group, a bromomethyl group, a 2-chloroethyl group, a trifluoromethyl group, a methoxymethyl group, a methoxy ethyoxy ethyl group, an allyloxy methyl group, a phenoxy methyl group, a methyl thiomethyl group, a tolylthiomethyl group, an ethyl amino ethyl group, a diethyl amino propyl group, a morpholinopropyl group, an acetyloxy methyl group, a benzoyloxy methyl group, an N-cyclohexyl carbamoyloxy ethyl group, an N-phenyl carbamoyloxy ethyl group, an acetyl aminoethyl group, an N-methyl zenzoyl aminopropyl group, a 2-oxoethyl group, a 2-oxopropyl group, a carboxy propyl group, a methoxy carbonyl ethyl group, an aryloxycarbonyl butyl group, a chlorophenoxy carbonyl methyl group, a carbamoyl methyl group, an N-methyl carbamoyl ethyl group, an N,N-dipropyl carbamoyl methyl group, an N-(methoxyphenyl)carbamoyl ethyl group, an N-methyl-N-(sulfophenyl)carbamoyl methyl group, a sulfobutyl group, a sulfonatopropyl group, a sulfonatobutyl group, a sulfamoyl butyl group, an N-ethyl sulfamoyl methyl group, an N,N-dipropyl sulfamoyl propyl group, an N-tolylsulfamoyl propyl group, an N-methyl-N-(phosphonophenyl)sulfamoyl octyl group, a phosphono butyl group, a phosphonato hexyl group, a diethyl phosphonobutyl group, a diphenyl phosphonopropyl group, a methyl phosphonobutyl group, a methyl phosphonato butyl group, a tolylphosphonohexyl group, a tolyphosphonato hexyl group, a phosphonoxy propyl group, a phosphonatoxy butyl group, a benzyl group, a phenethyl group, an α-methylbenzyl group, a 1-methyl-1-phenylethyl group, a p-methylbenzyl group, a cinnamyl group, an allyl group, a 1-propenyl methyl group, a 2-butenyl group, a 2-methyl allyl group, a 2-methyl propenyl methyl group, a 2-propyl group, a 2-butynyl group, and a 3-butynyl group.

Specific examples of aryl group preferable as R⁷⁴, R⁷⁵, or R⁷⁶ include aryl groups in which one to three benzene rings form a condensed ring, and aryl groups in which a benzene ring and five-membered unsaturated ring form a condensed ring. Specific examples thereof include a phenyl group, a naphthyl group, an anthryl group, a phenanthryl group, an indenyl group, an acenaphthenyl group, and a fluorenyl group, and, among them, a phenyl group and a naphthyl group are more preferable.

Specific examples of substituted aryl group preferable as R⁷⁴, R⁷⁵, or R⁷⁶ include substituted aryl groups that have a group of a monovalent non-metallic atomic group (other than a hydrogen atom) as a substituent on a ring-forming carbon atom in the above-mentioned aryl group. Preferable examples of the substituent include the alkyl group, the substituted alkyl group, and substituents that are shown as a substituent in the substituted alkyl group. Preferable specific examples of the substituted aryl group include a biphenyl group, a tolyl group, a xylyl group, a mesityl group, a cumenyl group, a chlorophenyl group, a bromophenyl group, a fluorophenyl group, a chloromethyl phenyl group, a trifluoromethyl phenyl group, a hydroxyl phenyl group, a methoxy phenyl group, a methoxy ethoxy phenyl group, an allyloxy phenyl group, a phenoxy phenyl group, a methylthio phenyl group, a tolylthio phenyl group, an ethyl amino phenyl group, a diethyl amino phenyl group, a morpholino phenyl group, an acetyloxy phenyl group, a benzoyloxy phenyl group, an N-cyclohexyl carbamoyloxy phenyl group, an N-phenyl carbamoyloxy phenyl group, an acetyl amino phenyl group, an N-methyl benzoyl amino phenyl group, a carboxy phenyl group, a methoxy carbonyl phenyl group, an aryloxycarbonyl phenyl group, a chlorophenoxy carbonyl phenyl group, a carbamoyl phenyl group, an N-methyl carbamoyl phenyl group, an N,N-dipropyl carbamoyl phenyl group, an N-(methoxyphenyl)carbamoyl phenyl group, an N-methyl-N-(sulfophenyl)carbamoyl phenyl group, a sulfophenyl group, a sulfonato phenyl group, a sulfamoyl phenyl group, an N-ethyl sulfamoyl phenyl group, an N,N-dipropyl sulfamoyl phenyl group, an N-tolyl sulfamoyl phenyl group, an N-methyl-N-(phosphonophenyl)sulfamoyl phenyl group, a phosphono phenyl group, a phosphonato phenyl group, a diethyl phosphono phenyl group, a diphenyl phosphono phenyl group, a methyl phosphono phenyl group, a methyl phosphonato phenyl group, a tolyl phosphono phenyl group, a tolylphosphonato phenyl group, an allylphenyl group, a 1-propenyl methyl phenyl group, a 2-butenyl phenyl group, a 2-methylallylphenyl group, a 2-methyl propenylphenyl group a 2-propynylphenyl group, a 2-butynylphenyl group, and a 3-butynylphenyl group.

Meanwhile, more preferable examples of R⁷⁵ and R⁷⁶ include substituted or unsubstituted alkyl groups. In addition, more preferable examples of R⁷⁴ include substituted or unsubstituted aryl groups. Although the reasons are not clear, it is presumed to be because when such substituents are included, the interaction between the electron excitation state generated by light absorption and the initiator compound is particularly large, and an efficiency of generating a radical, acid, or base of the initiator compound is improved.

Next, A⁵ in formula (XVIII) will be described. A⁵ represents an aromatic ring that may have a substituent or a hetero ring that may have a substituent. Specific examples of the aromatic ring that may have a substituent or the hetero ring that may have a substituent include the same compounds as described in the description of R⁷⁴, R⁷⁵, or R⁷⁶ in formula (XVIII).

In particular, preferable examples of A⁵ include aryl groups having an alkoxy group, a thioalkyl group, or an amino group, and particularly preferable examples of A⁵ include aryl groups having an amino group.

Next, Y in formula (XVIII) will be described. Y is a non-metallic atom or non-metallic atomic group which is directly bonded to a nitrogen-containing heterocyclic ring via a double bond in formula (XVIII), and represents an oxygen atom, a sulfur atom, or ═N(R⁷⁴).

In addition, X in formula (XVIII) represents an oxygen atom, a sulfur atom, or —N(R⁷⁴)—.

Next, compounds represented by the following formula (XVIII-1), which are preferable embodiments of the compounds which are used in the invention and represented by formula (XVIII), will be described.

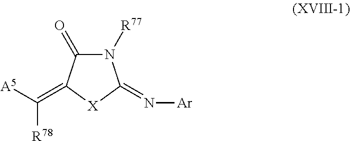

In formula (XVIII-1), A⁵ represents an aromatic ring that may have a substituent or a hetero ring that may have a substituent; X represents an oxygen atom, a sulfur atom, or —N(R⁷⁴)—; R⁷⁴, R⁷⁷, and R⁷⁸ each independently represent a hydrogen atom or a monovalent non-metallic atomic group; A⁵ and R⁷⁴ may bond to each other so as to form an aliphatic or aromatic ring; and R⁷⁷ and R⁷⁸ may bond to each other so as to form an aliphatic or aromatic ring. Ar represents an aromatic ring having a substituent or a hetero ring having a substituent. However, the substituent on the Ar skeleton needs to have a sum of the Hammett value of larger than 0. Here, the sum of the Hammett value being larger than 0 refers to the fact that the hetero ring has a substituent, and the Hammett value of the substituent is larger than 0, or the hetero ring have plural substituents, and the sum of the Hammett values of the substituents is larger than 0.

In formula (XVIII-1), A⁵ and R⁷⁴ have the same definitions as those in the formula (XVIII), R⁷⁷ has the same definition as R⁷⁵ in formula (XVIII), and R⁷⁸ has the same definition as R⁷⁶ in formula (XVIII). In addition, Ar represents an aromatic ring having a substituent or a hetero ring having a substituent, and has the same definition as A⁵ in formula (XVIII).

However, it is essential that the substituent which may be introduced to Ar in formula (XVIII-1) have a sum of Hammett value of 0 or more, and examples of the substituent include a trifluoromethyl group, a carbonyl group, an ester group, a halogen atom, a nitro group, a cyano group, a sulfoxide group, an amide group, and a carboxyl group. The Hammett values of the substituents will be hereinafter shown: a trifluoromethyl group (—CF₃, m: 0.43, p: 0.54), a carbonyl group (for example, —COH m: 0.36, p: 0.43), an ester group (—COOCH₃, m: 0.37, p: 0.45), a halogen atom (for example, Cl, m: 0.37, p: 0.23), a cyano group (—CN, m: 0.56, p: 0.66), a sulfoxide group (for example, —SOCH₃, m: 0.52, p: 0.45), an amide group (for example, —NHCOCH₃, m: 0.21, p: 0.00), a carboxyl group (—COOH, m: 0.37, p: 0.45). The recitation in the parenthesis represents an introduction position of the substituent in the aryl skeleton and the Hammett values thereof, and “(m: 0.50)” indicates that, when the substituent is introduced to a meta position, the Hammett value is 0.50. Among them, preferable examples of Ar include phenyl groups having a substituent, and preferable substituents on the Ar skeleton include an ester group and a cyano group. Regarding the substitution position, the substituent is particularly preferably located at the ortho position in the Ar skeleton.

Hereinafter, preferable specific examples [example compound (F1) to example compound (F56)] of the sensitizing colorants represented by formula (XVIII) according to the invention will be shown, but the invention is not limited thereto.

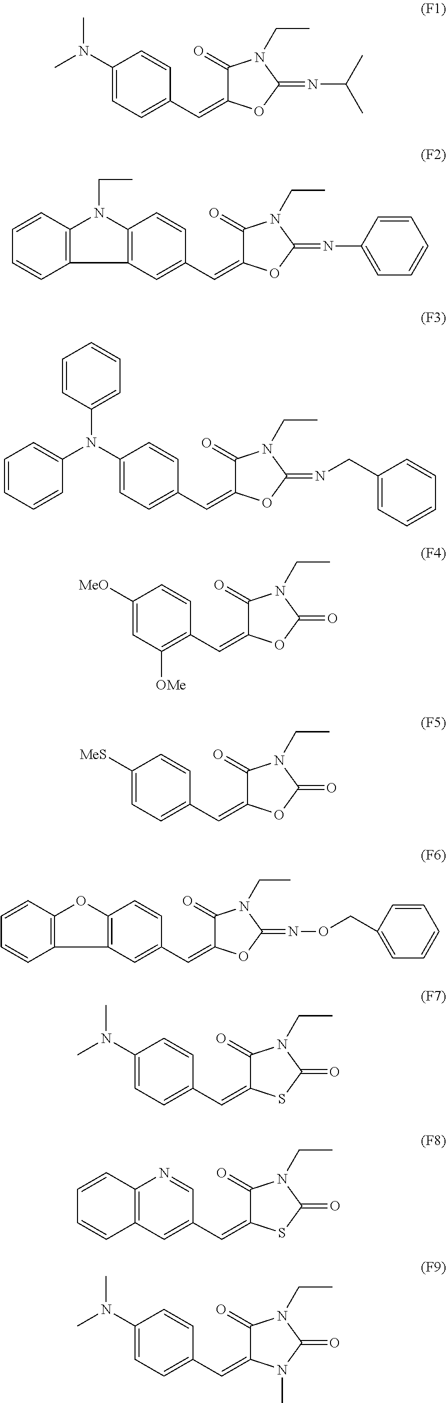

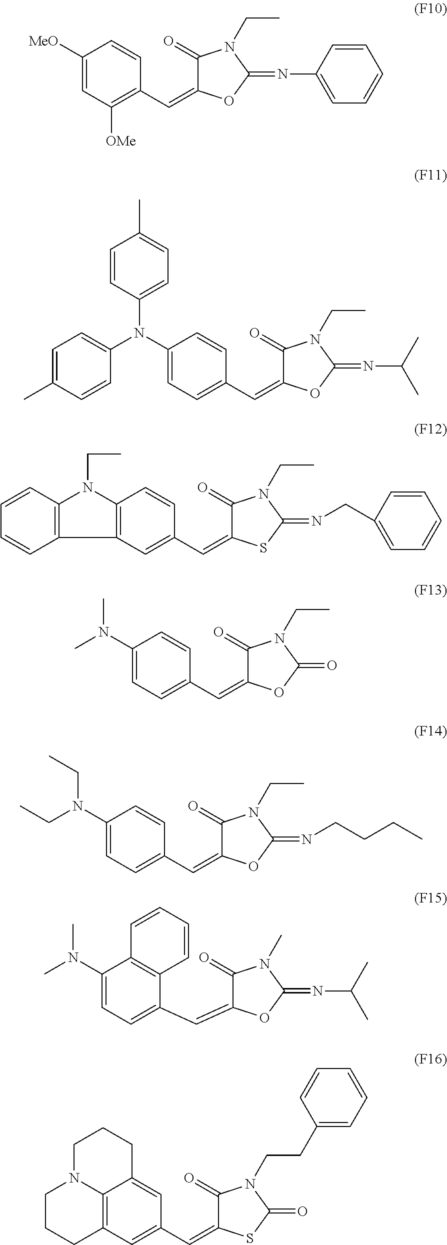

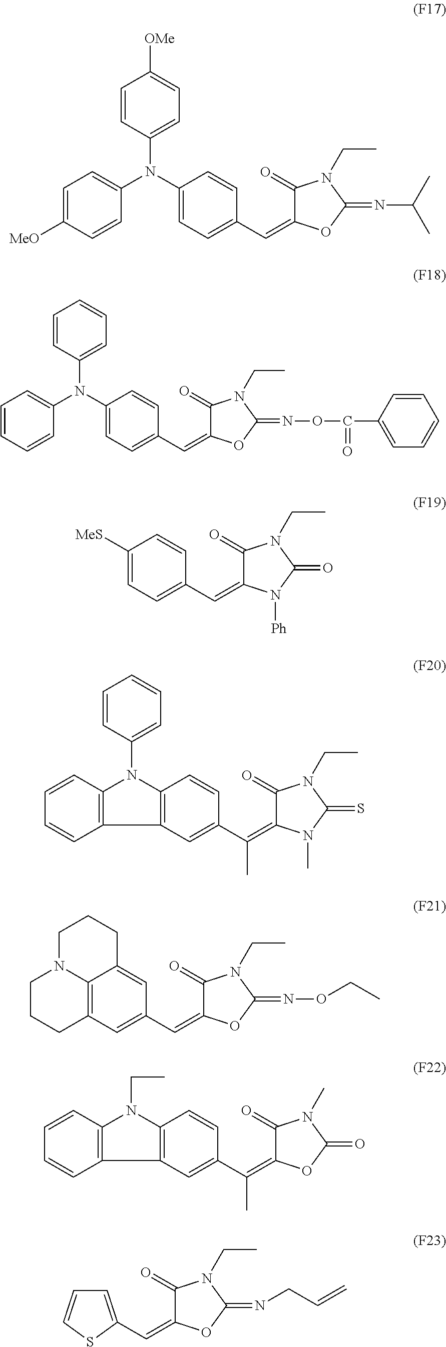

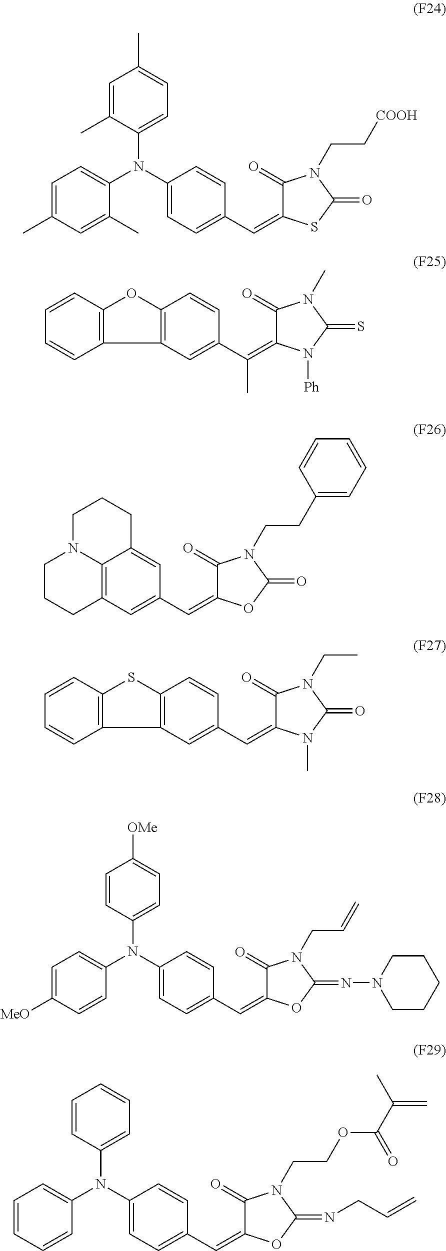

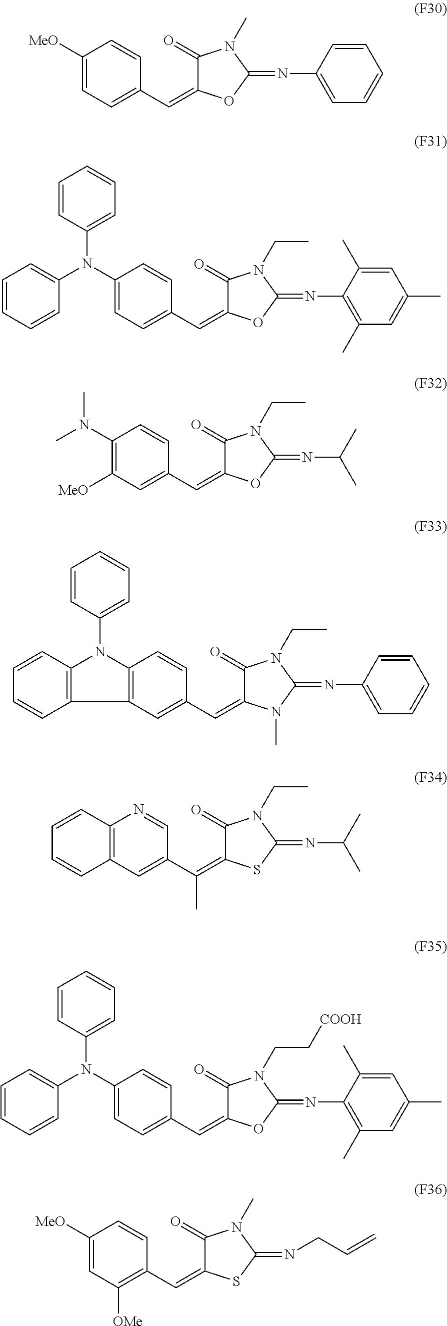

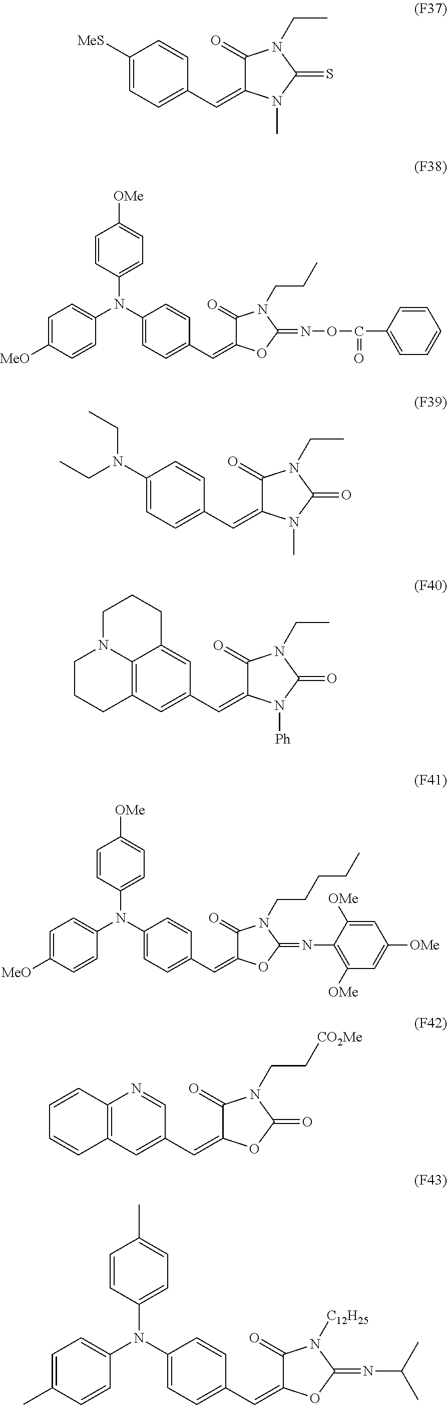

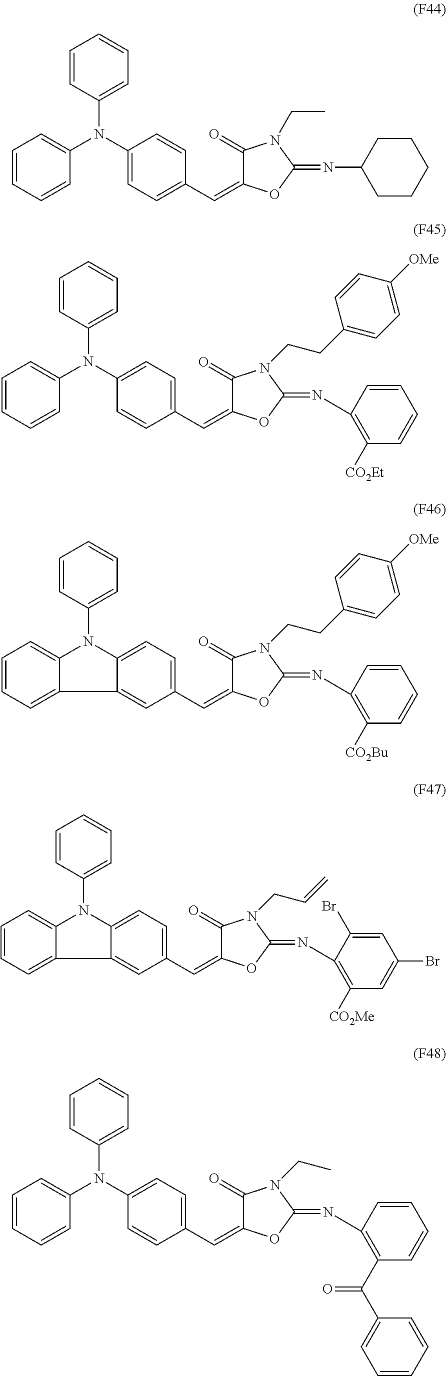

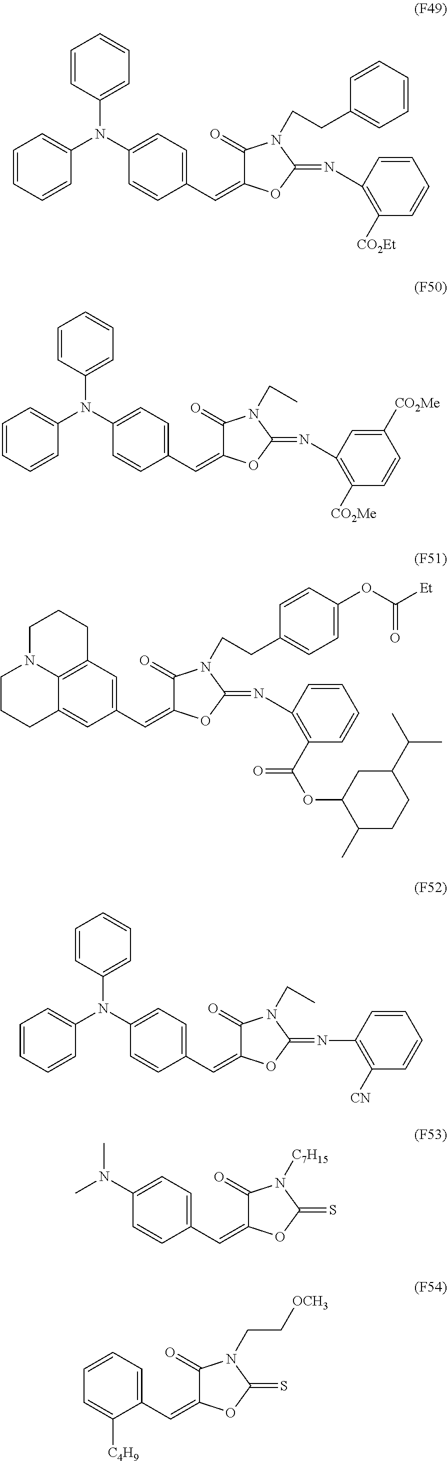

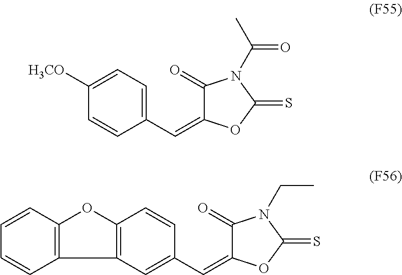

Among the sensitizing colorants applicable to the invention, the compounds represented by formula (XVIII) are preferable from the viewpoint of deep portion curing properties.

The sensitizing colorant may be subjected to a variety of chemical modifications described below, in order to improve the characteristics of a photosensitive composition of the invention. For example, when the sensitizing colorant and an addition polymerizable compound structure (for example, an acryloyl group or a methacryloyl group) are boned with each other via a covalent bond, an ionic bond, a hydrogen bond, or the like, the strength of a crosslinking-cured film is increased, or an effect of suppressing unnecessary precipitation of the colorant from the crosslinking-cured film is improved.

The content of the sensitizing colorant is preferable from 0.01% by mass to 20% by mass, more preferably from 0.01% by mass to 10% by mass, and still more preferably from 0.1% by mass to 5% by mass, with respect to the total solid content of a colored photosensitive composition for the color filter of the invention.

When the content of the sensitizing colorant is in the above ranges, a high sensitivity with respect to the exposure wavelength of an ultrahigh pressure mercury lamp is attained, deep portion curing properties are attained, and it is preferable in tennis of development margin and pattern forming properties.

Hydrogen-Donating Compound

The photocurable composition used in the invention preferably contains a hydrogen-donating compound. The hydrogen-donating compound in the invention has an action of further improving the sensitivity of the sensitizing colorant or photopolymerization initiator with respect to active radiant rays, suppressing polymerization inhibition of the polymerizable compound caused by oxygen, or the like.

Examples of the hydrogen-donating compound include amines such as the compounds as described in “Journal of Polymer Society” by M. R. Sander, Vol. 10, page 3173 (1972), JP-B No. 44-20189, JP-A No. 51-82102, JP-A No. 52-134692, JP-A No. 59-138105, JP-A No. 60-84305, JP-A No. 62-18537, JP-A No. 64-33104, and Research Disclosure No. 33825, and specifically include triethanolamine, p-dimethylamino benzoic acid ethyl ester, p-formyl dimethylaniline, and p-methylthio dimethylaniline.

Additional examples of the hydrogen-donating compound include thiols and sulfides, for example, thiol compounds disclosed in JP-A No. 53-702, JP-B No. 55-500806, and JP-A No. 5-142772, disulfide compounds in JP-A No. 56-75643, and the like, and specifically include 2-mercapto benzothiazole, 2-mercapto benzoxazole, 2-mercapto benzoimidazole, 2-mercapto-4(3H)-quinazolines β-mercapto naphthalene, and the like.

In addition, further additional examples of the hydrogen-donating compound include amino acid compounds (for example, N-phenyl glycine), organometallic compounds as described in JP-B No. 48-42965 (for example, tributyltin acetate), hydrogen donor as described in JP-B No. 55-34414, and sulfur compounds as described in JP-A No. 6-308727 (for example, trithiane).

The content of the hydrogen-donating compound is preferable in a range of from 0.1% by mass to 30% by mass, more preferably in a range of from 0.5% by mass to 25% by mass, and still more preferably in a range of from 1.0% by mass to 20% by mass, with respect to the mass of the total solid content of the photocurable composition, from the viewpoint of improvement in curing rate due to the balance between polymerization growth rate and chain transfer.

Fluorine-Containing Organic Compound

The photocurable composition used in the invention may also contain a fluorine-containing organic compound.

When the photocurable composition contains a fluorine-containing organic compound, liquid characteristics (particularly, fluidity) of a coating solution obtained using the photocurable composition in the invention are improved, and the uniformity of coating thickness or liquid-saving properties are improved. In other words, the surface tension between a surface to be coated and the coating solution is reduced so that wetting properties to the surface to be coated are improved, and coating properties onto the surface to be coated is improved. Therefore, it is effective for forming a film having a uniform thickness with little thickness unevenness, even when an approximately several μm-thick thin film is formed using a small amount of the solution.

The proportion of fluorine in the fluorine-containing organic compound is preferably from 3% by mass to 40% by mass, more preferably from 5% by mass to 30% by mass, and particularly preferably from 7% by mass to 25% by mass. When the proportion of fluorine is in the above ranges, it is effective from the viewpoints of coating thickness uniformity and liquid-saving properties, and solubility in the composition is also favorable.

Examples of the fluorine-containing organic compound include MEGAFAC F171, MEGAFAC F172, MEGAFAC F173, MEGAFAC F177, MEGAFAC F141, MEGAFAC F142, MEGAFAC F143, MEGAFAC F144, MEGAFAC R30, MEGAFAC F437 (all manufactured by DIC Corporation), FLUORAD FC430, FLUORAD FC431, FLUORAD FC171 (all manufactured by Sumitomo 3M Ltd.), and SURFLON S-382, SURFLON SC-101, SURFLON SC-103, SURFLON SC-104, SURFLON SC-105, SURFLON SC1068, SURFLON SC-381 SURFLON SC-383, SURFLON 5393, SURFLON KH-40 (all manufactured by Asahi Glass Co., Ltd.).

As described above, the fluorine-containing organic compound is particularly effective for preventing coating unevenness or thickness unevenness when the coated film is made to be thin. Furthermore, the fluorine-containing organic compound is also effective when the composition is applied by slit coating in which lack of liquid is liable to occur.

The amount of the fluorine-containing organic compound to be added is preferably from 0.001% by mass to 2.0% by mass, and more preferably from 0.005% by mass to 1.0% by mass, with respect to the total mass of the photocurable composition.

Thermal Polymerization Initiator

It is also effective that the photocurable composition used in the invention contain a thermal polymerization initiator. Examples of the thermal polymerization initiator include a variety of azo compounds and peroxide compounds. The azo compounds include azobis-based compounds, and the peroxide compounds include ketone peroxide, peroxy ketal, hydroperoxide, dialkyl peroxide, diacyl peroxide, peroxy ester, peroxy dicarbonate, and the like.

Thermal Polymerization Component

It is also effective that the photocurable composition used in the invention contain a thermal polymerization component, in order to increase the strength of a film. The thermal polymerization component is preferably an epoxy compound.

The epoxy compound refers to compounds that have two or more epoxy rings in the molecule thereof, such as bisphenol A compounds, cresol novolac compounds, biphenyl compounds, and alicyclic epoxy compounds.

Examples of the bisphenol A epoxy compound include EPOTOHTO YD-115, YD-118T, YD-127, YD-128, YD-134, YD-8125, YD-7011R, ZX-1059, YDF-8170, YDF-170, and the like (all manufactured by Tohto Kasei Co., Ltd.), DENACOL EX-1101, EX-1102, EX-1103, and the like (all manufactured by Nagase ChemteX Corporation), PLACCEL GL-61, GL-62, G101, G102 (all manufactured by Daicel Chemical Industries, Ltd.), and also bisphenol F compounds and bisphenol S compounds, which are similar to the above compounds. In addition, epoxy acrylates such as EBECRYL 3700, 3701, 600 (all manufactured by Daicel UCB), and the like may also be used.

Examples of the cresol novolac epoxy compound include EPOTOHTO YDPN-638, YDPN-701, YDPN-702, YDPN-703, YDPN-704, and the like (all manufactured by Tohto Kasei Co., Ltd.) and DENACOL EM-125 and the like (manufactured by Nagase ChemteX Corporation). Examples of the biphenyl type compound include 3,5,3′,5′-tetramethyl-4,4′-diglycidyl biphenyl and the like, and examples of the alicyclic epoxy compound include CELLOXIDE 2021, 2081, 2083, 2085, EPOLEAD GT-301, GT-302, GT-401, GT-403, EHPE-3150 (all manufactured by Daicel Chemical Industries, Ltd.), SANTOHTO ST-3000, ST-4000, ST-5080, ST-5100, and the like (all manufactured by Tohto Kasei Co., Ltd.). In addition, 1,1,2,2-tetrakis(p-glycidyloxyphenyl)ethane, tris(p-glycidyloxyphenyl)methane, triglycidyl tris(hydroxyethyl)isocyanurate, diglycidyl o-phthalate, diglycidyl terephthalate, additionally, glycidyl esters obtained by modifying dimer acid in the skeletons of EPOTOHTO YH-434, YH-434L, bisphenol A type epoxy resin, which are amine epoxy resins, may also be used.

Surfactant

From the viewpoint of improving coating properties, the photocurable composition used in the invention is preferably formed using a variety of surfactants, and a variety of surfactants such as nonionic surfactants, cationic surfactants, and anionic surfactants may be used. Among them, fluorine-containing surfactants which are nonionic and have a perfluoroalkyl group are preferable.

Specific examples of the fluorine-containing surfactant include MEGAFAC (registered trademark) series (manufactured by DIC Corporation), and FLUORAD (registered trademark) series (manufactured by Sumitomo 3M Ltd.).

In addition, phthalocyanine derivatives (commercially available product EFKA-745 (manufactured by Morishita & Co., Ltd.)); cationic surfactants such as an organosiloxane polymer KP341 (manufactured by Shin-Etsu Chemical Co., Ltd.), (meth)acrylic (co)polymers POLYFLOW No.75, No.90, and No.95 (manufactured by Kyoeisha Chemical Co., Ltd.), and W001 (manufactured by Yusho Co., Ltd.); nonionic surfactants such as polyoxyethylene lauryl ether, polyoxyethylene stearyl ether, polyoxyethylene oleyl ether, polyoxyethylene octylphenyl ether, polyoxyethylene nonylphenyl ether, polyethylene glycol dilaurate, polyethylene glycol distearate, sorbitan fatty esters (those manufactured by BASF, such as PLURONIC L10, L31, L61, L62, 10R5, 17R2, 25R2, TETRONIC 304, 701, 704, 901, 904, 150R1); and anionic surfactants such as W004, W005 and W017 (manufactured by Yusho Co., Ltd.); and the like may also be used.

Other Additives

Besides the above, specific examples of other additives include a filler such as glass or alumina; an alkali-soluble resin such as an itaconic acid copolymer, a crotonic acid copolymer, a maleic acid copolymer, a partially esterified maleic acid copolymer, an acidic cellulose derivative, a polymer that has a hydroxyl group to which an acid anhydride is added, an alcohol-soluble nylon, and a phenoxy resin foamed of bisphenol A and epichlorohydrin; polymer dispersants such as EFKA-46, EFKA-47, EFKA-47EA, EFKA POLYMER 100, EFKA POLYMER 400, EFKA POLYMER 401, EFKA POLYMER 450 (manufactured by Morishita & Co., Ltd.), DISPERSE AID 6, DISPERSE AID 8, DISPERSE AID 15, or DISPERSE AID 9100 (manufactured by San Nopco Ltd.); a variety of SOLSPERSE dispersants such as SOLSPERSE 3000, 5000, 9000, 12000, 13240; 13940, 17000, 24000, 26000, and 28000 (all manufactured by Lubrizol Japan Limited); ADEKA PLURONIC L31, F38, L42, L44, L61, L64, F68, L72, P95, F77, P84, F87, P94, L101, P103, F108, L121, P-123 (all manufactured by ADEKA Corporation), IONET S-20 (manufactured by Sanyo Chemical Industries, Ltd.); an ultraviolet absorbent such as 2-(3-t-butyl-5-methyl-2-hydroxyphenyl)-5-chlorobenzo triazole or alkoxy benzophenone; and an aggregation inhibitor such as sodium polyacrylate.

In addition, in order to enhance the alkali solubility of an uncured portion, and to additionally improve the development properties of the photocurable composition, it is preferable to add an organic carboxylic acid, preferably a low-molecular-weight organic carboxylic acid having a molecular weight of 1000 or less, to the photocurable composition.

Specific examples of the organic carboxylic acid include aliphatic monocarboxylic acids such as fouiiic acid, acetic acid, propionic acid, butyric acid, valeric acid, pivalic acid, caproic acid, diethylacetic acid, enanthic acid, or caprylic acid; aliphatic dicarboxylic acids such as oxalic acid, malonic acid, succinic acid, glutaric acid, adipic acid, pimelic acid, suberic acid, azelaic acid, sebacic acid, brassylic acid, methylmalonic acid, ethylmalonic acid, dimethylmalonic acid, methylsuccinic acid, tetramethylsuccinic acid, or citraconic acid; aliphatic tricarboxylic acids such as tricarballylic acid, aconitic acid, or camphoronic acid; aromatic monocarboxylic acids such as benzoic acid, toluic acid, cuminic acid, hemellitic acid, or mesitylenic acid; aromatic polycarboxylic acids such as phthalic acid, isophthalic acid, terephthalic acid, trimellitic acid, trimesic acid, mellophanic acid, or pyromellitic acid; and other carboxylic acids, such as phenylacetic acid, hydratropic acid, hydrocinnamic acid, mandelic acid, phenylsuccinic acid, atropic acid, cinnamic acid, methyl cinnamate, benzyl cinnamate, cinnamylideneacetic acid, coumaric acid or umbellic acid.

Thermal Polymerization Inhibitor

In addition to the above, a thermal polymerization inhibitor may be added to the photocurable composition used in the invention.

Examples of the thermal polymerization inhibitor useful in the invention include hydroquinone, p-methoxyphenol, di-t-butyl-p-cresol, pyrogallol, t-butylcatechol, benzoquinone, 4,4′-thiobis(3-methyl-6-t-butylphenol), 2,2′-methylenebis(4-methyl-6-t-butyl phenol), and 2-mercaptobenzoimidazole.

Preparation of Photocurable Composition

The photocurable composition used in the invention may be prepared by selecting, according to necessity, and mixing the respective components mentioned above.

It is preferable to prepare a pigment dispersion composition as described above, and then produce the photocurable composition used in the invention using the pigment dispersion composition.

In a case in which the pigment dispersion composition is used to prepare the photocurable composition used in the invention, the content of the pigment dispersion composition is such that the content of the pigment is preferably in a range of from 30% by mass to 60% by mass, more preferably in a range of from 35% by mass to 60% by mass, and still more preferably in a range of from 40% by mass to 60% by mass, with respect to the total solid content (mass) of the photocurable composition.

When the content of the pigment dispersion composition is in the above ranges, it is effective to secure sufficient color density and excellent color characteristics.

Color Filter and Method of Manufacturing the Same

The color filter of the invention has a green area on a substrate, and may also have a red (R) area, a blue (B) are, and other color areas in addition to the green area on the substrate.

As a method of manufacturing the color filter, it is preferable to use a method in which coating, prebaking, light exposure, and development of the photocurable composition are performed repeatedly so as to form colored patterns. When a photocurable composition that contains a green pigment or cyan pigment and the specific yellow dye (the above-mentioned photocurable composition) is used in this method, the green area in the color filter of the invention is formed as a colored pattern. In addition, it is also possible to faun a red (R) area, a blue (B) area, or other color areas as colored patterns by changing the types of the pigment and the dye in the photocurable composition.

Hereinafter, the color filter of the invention will be described in detail by referring to a method of manufacturing the same.

As described above, a method of manufacturing a color filter preferable in the invention includes the respective processes of coating, prebaking, exposure, and development. A single color or multicolor (three or four colors) colored pattern (colored area) is fonned by undergoing the respective processes, and the color filter is obtained.

The above method enables manufacturing high-quality color filters that are used in a variety of image display apparatuses with less difficulties in the processes and at low costs.

Hereinafter, the respective processes will be described in detail.

Coating Process

First, a substrate used in the coating process will be described. Examples of the substrate used in the invention include alkali-free glass, soda glass, PYREX (registered trademark) glass, quartz glass, all of which are used for liquid crystal display elements and the like, the same to which a transparent conductive film has been attached, and photoelectric conversion element substrates that are used for solid imaging element and the like, for example, silicon substrates or plastic substrates.

On the substrate, a black matrix that separates respective pixels may be formed, or a transparent resin layer may be provided for promoting adhesion and the like.

The plastic substrate preferably has a gas barrier layer and/or a solvent-resistant layer on the surface thereof.

In addition to the above, a driving substrate in which a thin film transistor (TFT) of a thin film transistor (TFT) type color liquid crystal display apparatus is disposed (hereinafter referred to as the “TFT type liquid crystal driving substrate”) may be used, and a colored pattern obtained by using the photocurable composition used in the invention is foiiued on the driving substrate, whereby a color filter is manufactured.

Examples of the substrate in the TFT type liquid crystal driving substrate include glass, silicon, polycarbonate, polyester, aromatic polyamide, polyamide imide, and polyimide. The substrate may be subjected to an appropriate pretreatment, such as a chemical treatment using a silane coupling agent, a plasma treatment, ion plating, sputtering, a gas-phase reaction method, or vacuum deposition, if desired. For example, a substrate that has a passivation film, such as a silicon nitride film, formed on a surface of the TFT type liquid crystal driving substrate may be used.

In the coating process, a method of applying the photocurable composition used in the invention to the substrate is not particularly limited, but is preferably a method in which a slit nozzle is used (hereinafter referred to as the slit nozzle coating method), such as a slit-and-spin method or a spinless coating method.

In the slit nozzle coating method, the conditions of the slit-and-spin coating method and the spinless coating method vary depending on the size of the substrate to be coated. For example, when a fifth generation glass substrate (1,100 mm×1,250 mm) is coated by the spinless coating method, the amount of the photocurable composition ejected from a slit nozzle is generally 500 microliters/second to 2,000 microliters/second, and preferably 800 microliters/second to 1,500 microliters/second, and the coating rate is generally 50 mm/second to 300 mm/second, and preferably 100 mm/second to 200 mm/second.

The solid content concentration of the photocurable composition that is used in the coating process is from 12% by mass to 18% by mass. When the solid content concentration of the photocurable composition is in the above range, color unevenness and slit coating unevenness are suppressed. Meanwhile, the solid content concentration of the photocurable composition is more preferably from 13% by mass to 17.5% by mass, and from 14% by mass to 17% by mass.

If necessary, the solid content concentration is adjusted by condensation and dilution using the above-mentioned solvent.

The viscosity of the photocurable composition that is used in the coating process is preferably from 4.5 mPa·s to 6.5 mPa, more preferably from 4.0 mPa·s to 7.0 mPa, and particularly preferably from 5.0 mPa·s to 6.0 mPa, at room temperature (25° C.).

When the viscosity of the photocurable composition that is used in the coating process is in the above ranges, the thickness of the coated film made from the coated photocurable composition becomes uniform.

In a case in which a coated film of the photocurable composition is formed on the substrate, the thickness of the coated film (after the prebaking treatment) is generally from 0.3 μm to 5.0 μm, desirably from 0.5 μm to 4.0 μm, and most desirably from 0.5 μm to 3.0 μm.

In the case of a color filter for a solid imaging element, the thickness of the coated film (after the prebaking treatment) is preferably in a range of from 0.5 μm to 5.0 μm.

Prebaking Process

After the coating process, the coated film is subjected to a prebaking treatment. If necessary, a vacuum treatment may be carried out before the prebaking.

Conditions of vacuum drying are such that the degree of vacuum is generally 0.1 torr to 1.0 torn and preferably approximately 0.2 torr to 0.5 torr.

In addition, the prebaking treatment may be carried out in a temperature range of 50° C. to 140° C., preferably approximately 70° C. to 110° C. for 10 seconds to 300 seconds using a hot plate, an oven, or the like. Meanwhile, a high frequency treatment or the like may be used in combination with the prebaking treatment. The high frequency treatment may also be used singly.

Exposure Process

In the exposure process, the coated film formed from the photocurable composition as described above is exposed to light through a predetermined master pattern.

Radiation rays that are used for the exposure are particularly preferably ultraviolet rays such as a g ray, an h ray, an i ray, or a j ray.

When a color filter for a liquid crystal display apparatus is to be manufactured, exposure is preferably carried out using mainly an h ray or an i ray with a proximity exposure apparatus or a mirror projection exposure apparatus.

When a color filter for a solid imaging element is to be manufactured, it is preferable to use mainly an i ray with a stepper exposure apparatus.

Meanwhile, when a color filter is manufactured using the TFT type liquid crystal driving substrate, a photomask which has a pattern for forming pixels (colored pattern) and a pattern for forming a through hole or U-shaped cavity, is used.

Development Process

In the development process, an uncured portion in the exposed coated film after the light exposure is ejected in a developer so that only a cured portion remains on the substrate.

The development temperature is generally from 20° C. to 30° C., and the development time is from 20 seconds to 90 seconds.

Any solution may be used as the developer as long as the solution is capable of dissolving the coated film in the uncured portion of the photocurable composition, but does not dissolve the cured portion.

Specifically, a combination of a variety of organic solvents or an alkali aqueous solution may be used.

Examples of the organic solvent used for the development include the above-mentioned solvents which may be used for preparing the photocurable composition used in the invention.

In addition, examples of the alkali aqueous solution include alkali aqueous solutions obtained by dissolving an alkali compound such as sodium hydroxide, potassium hydroxide, sodium carbonate, sodium hydrogen carbonate, sodium silicate, sodium metasilicate, ammonia water, ethylamine, diethylamine, dimethyl ethanolamine, tetramethylammonium hydroxide, tetraethylammonium hydroxide, tetramethylammonium hydroxide, tetraethylammonium hydroxide, choline, pyrrole, piperidine, or 1,8-diazabicyclo-[5,4,0]-7-undecene, so that the concentration thereof becomes 0.001% by mass to 10% by mass, and preferably 0.01% by mass to 1% by mass.

An appropriate amount of a water-soluble organic solvent, such as methanol or ethanol, surfactant, or the like may be added to the alkali aqueous solution.

The development method may be any of a dipping method, a shower method, a spray method, and the like, and may be a combination thereof with a swing method, a spin method, an ultrasonic method, or the like. A surface to be developed may be wetted with water or the like in advance before the surface to be developed is brought into contact with the development fluid, so as to prevent development unevenness. In addition, the development may be carried out while the substrate is maintained at a slant.

In addition, puddle development may also be used when a color filter for a solid imaging element is to be manufactured.

After the development treatment, a rinsing treatment is carried out to wash and remove the excessive developer, followed by drying.

In general, the rinsing treatment is carried out using water. However, for the purpose of liquid-saving, a method in which pure water is used in the final washing, while used pure water is used in the initial phase of washing, a method in which the substrate is maintained at a slant while washing, or a method in which ultrasonic application is jointly used, may be used.

After the drying, generally, a heating treatment at 100° C. to 250° C. is carried out.

The heating treatment (post-baking) may be carried out in a continuous or batch manner using heating means such as a hot plate, a convection oven (hot air circulation-type dryer), or a high frequency heater, so that the coated film after the development is subjected to the above conditions.

The post-baking is a process for achieving complete curing and making the pattern shape after the development a forward-tapered shape through thermal deformation. It is usual to carry out heating at from 200° C. to 250° C. (hard baking).

By sequentially repeating the above processes for respective colors according to the desired number of hues, a color filter having a cured film (colored pattern) with plural colors formed therein is manufactured.

A use of the color filter as the colored pattern (mainly the colored area) has been mainly described as the use of the photocurable composition used in the invention, but the photocurable composition may also be applied to formation of a black matrix that separates colored patterns (pixels) of the color filter.

The black matrix on the substrate may be formed by subjecting a photocurable composition that contains a processed pigment of black pigment such as carbon black or titanium black, to the respective processes of coating, exposure, and development, and then, if necessary, the post-baking.

Image Display Apparatus

The image display apparatus of the invention includes the color filter of the invention. The color filter includes at least three colors of RGB, and, among them, the green (G) color filter includes the specific pigment described above.

The configuration of the color filter is not limited thereto, and the configuration may include, for example, not only RGB but also RGGB or RGBW. Here, “W” refers to white.

In addition, an RGB color filter that includes the G color filter of the invention may be preferably used for manufacturing of a transmission band limited filter that is used in an ordinary LCD, and also be used for an organic EL display in which a blue LCD element is used as a light source. In this case, the filter is used as a color conversion color filter that receives blue light rays and converts into red or green. In the transmission band limited color filter, a resist in which pigments are dispersed is used, and, in the color conversion color filter, a resist in which fluorescent colorants are mixed is used. They may be formed by exposure, development, and sintering, as an ordinary negative resist. The detail has been described above.

More specific embodiments of the image display apparatus of the invention will be described.

### Configuration of LCD Display Apparatus

In the case of an LCD in which a cold cathode fluorescent lamp (CCFL), an LED light source, or the like is used as a backlight, the display apparatus of the invention may be obtained by manufacturing a liquid crystal panel in which a polarization plate, an array substrate, a liquid crystal layer, an oriented film, the color filter of the invention, and the like are laminated, and overlapping the liquid crystal panel on the light source. In addition, use of well-known methods, such as introduction of a light guide plate or a variety of optical characteristic-improvement film, is also preferable in order to improve display characteristics.

Meanwhile, a lot of well-known information, such as the “color TFT liquid crystal display revised version”, by Taisuke Yamazaki (2005, published by Kyoritsu Publishing Company), can be referenced for the detailed structure of the LCD display.

The liquid crystal display apparatus of the invention is manufactured using the color filter according to the invention. The liquid crystal display apparatus manufactured using the color filter has a high luminance and a favorable color reproducibility due to the use of the dye of the invention, and damage of color, which is caused by heat and the like during manufacturing of the color filter, is suppressed, and therefore clear images are be displayed.

An embodiment of the liquid crystal display apparatus is a liquid crystal display apparatus that has at least the color filter of the invention, a liquid crystal layer, and liquid crystal driving means (including a passive matrix driving mode and an active matrix driving mode) between a pair of substrates, at least one of which is a light transmissive substrate.

In addition, another embodiment of the liquid crystal display apparatus is a liquid crystal display apparatus that has at least the color filter of the invention, a liquid crystal layer, and liquid crystal driving means between a pair of substrates, at least one of which is a light transmissive substrate, in which the liquid crystal driving means has active elements (for example, a TFT) and black matrixes formed between the active elements.

The structures of the liquid crystal display apparatuses are described in, for example, “Next-generation liquid crystal display technologies” (by Tatsuo Uchida, Kogyo Chosakai Publishing Co., Ltd. published on 1994) as well as the “Color TFT liquid crystal display revised version”. In the invention, applicable display apparatuses are not particularly limited, and the invention may be applied to liquid crystal display apparatuses of various types as described in the “Next-generation liquid crystal display technologies”. Among them, the invention is effective particularly for a liquid crystal display apparatus of a color TFT mode.

The invention is also applicable to liquid crystal display apparatuses that have an enlarged view angle, such as those of an in-plane switching (IPS) mode and a multi-domain vertical alignment (MVA) mode, and such high color reproducibility as described above is equally expected. Meanwhile, various modes of the liquid crystal apparatus are described in detail, for example, on page 43 of “Latest trend of EL, PDP, LCD display technologies and market” (by the investigation and research section, Toray Research Center, published on 2001).

Liquid crystals usable in the liquid crystal display apparatus include a nematic liquid crystal, a cholesteric liquid crystal, a smectic liquid crystal, a ferroelectric liquid crystal, and the like.

Configuration of Organic EL Display Apparatus

In the case of an organic EL display in which a white organic EL is used as a light source, a panel, which is the display element of the invention, is obtained by laminating the color filters of the invention on a transparent substrate, and laminating a white light emitting layer that is laminated between a pair of electrode substrates. More specifically, for example, an embodiment configured by laminating the color filter, a TFT circuit, an organic EL layer, and a common electrode on a transparent substrate in this order, is preferable.

The white light emitting layer may have any configuration as long as white light rays are irradiated to the color filter by applying a voltage between the pair of electrode substrates in the configuration. Meanwhile, in a case in which the color filter obtained using the colored composition of the invention is used for forming an organic EL display, it is particularly useful for the display to have a configuration in which a light emitting method in which white light rays are irradiated by subtractive color mixing of blue light rays and orange light rays as the white light emitting layer is used, which achieves a display element in which color purity is high in the green colored area in the color filter, and color unevenness is suppressed.

Glass or plastic may be used as the transparent substrate used in the image display apparatus of the invention. For example, polyethylene terephthalate (PET), polyethylene naphthalate (PEN), polyethersulfone (PES), polyimide (PI), or the like may be used. In a case in which the transparent substrate is plastic, it is desirable to provide a barrier film formed of SiO₂, SiON, Al₂O₃, Y₂O₃, or the like, so as to prevent transmission of moisture or oxygen.

The TFT circuit that is used herein is, for example, a TFT circuit that has at least two or more TFTs and one or more capacitors, and may be driven by voltage or electric currents. Alternately, well-known TFT circuit structures may be used.

In addition, an oxide semiconductor may be used as the semiconductor layer of the TFT in the invention. Since the oxide semiconductor is transparent, it is possible to produce a transparent TFT when transparent materials are used for the electrodes or insulating layer, and deterioration of the numerical aperture is prevented. In addition, whereas a high-temperature process of 200° C. or higher is required to form an amorphous Si or poly-Si film in the related art, many oxide semiconductors favorably operate even when films are formed at a low temperature of room temperature to 200° C. or lower, and it is possible to carry out all of the subsequent processes (formation of a photolithography or organic EL layer, and common electrodes) at 200° C. or lower, and therefore there is an advantage of a little possibility of the color filter being damaged due to heat. Furthermore, when the color filter is manufactured at 200° C. or lower, plastic can be used for the substrate, and it is also possible to produce flexible EL displays.

In the related art, all the TFT semiconductor layers in the TFT circuit are formed on one surface; however, when an oxide semiconductor is used, the cheap sputtering method may be used, and therefore two layers or more of oxide semiconductors may be used, and it is possible to use oxide semiconductors that have been produced under different conditions so that the degree of freedom in circuit design is increased. For example, when semiconductors in a scanning TFT and a driving TFT are formed as separate layers, it is possible to separately use a TFT that has small off-electric currents for the scanning TFT and a TFT that has large on-electric currents for the driving TFT. Alternately, it is also possible to use an n-type TFT for one and a p-type TFT for the other. Furtheimore, depending on circuits, it becomes unnecessary to form an opening section in a first insulating layer or a second insulating layer, the reliability is increased, and the processes can be simplified.

An oxide that includes at least one element of In, Ga, Zn, Sn, and Mg may be used for the oxide semiconductor. Specific examples of the oxide include indium oxide, zinc oxide, tin oxide, ZnMg oxide, InGaZn oxide, In_{X}Zn_{1-X} oxide, In_{X}Sn_{1-X} oxide, In_{X}(Zn, Sn)_{1-X} oxide, GaSn oxide, InGaSn oxide, and InGaZnMg oxide. They may be used to form a film by sputtering, laser ablation, deposition, or the like.

Particularly, InGaZn oxide is a preferable material because a mobility of 5 cm²/Vs or higher is easily attained with favorable reproducibility, even when a film is formed by sputtering at any temperature of from room temperature to 200° C. In addition, InGaZnMg oxide has substantially the same mobility as InGaZn oxide, and, furthermore, is highly resistant against ultraviolet rays (i.e., rarely causes incorrect operation) owing to a large band gap thereof. Here, InGaZn oxide has a composition ratio close to In:Ga:Zn:O=1:1:1:4, and has characteristics not changed even when a few oxygen pores are present, and the metal composition slightly deviates in an actual situation, and therefore the composition ratio is allowed within In:Ga:Zn:O=(0.7 to 1.3):(0.7 to 1.3):(0.7 to 1.3):(3 to 4).

In addition, InGaZn oxide is basically in an amorphous state, but may partially contain a fine crystal structure. In addition, InGaZnMg oxide is obtained by substituting parts (50% or less) of Zn in InGaZn oxide with Mg. The sputter is preferably an RF or DC reactive sputter.

Indium tin oxide (ITO), indium zinc oxide (IZO), or the like is preferably used as the electrode.

An oxide film, nitride film, or the like of silicon oxide SiOx, silicon nitride SiNx, aluminum oxide Al₂O₃, tantalum oxide TaOx, yttrium oxide (Y₂O₃), tantalum nitride (TaNx), or the like is preferably used as an insulating layer.

These materials may also be used to form a film by sputtering, laser ablation, deposition, or the like at a temperature of from room temperature to 200° C. Particularly, reactive sputtering is preferable. After film formation, post annealing may be carried out. At this time, the temperature of the post annealing is also preferably 200° C. or lower.

In the invention, it is also possible to further use a transparent organic insulating layer. For example, a fluororesin, polyvinyl alcohol, epoxy, acryl, or the like may be used. When a photosensitive resin is used, patterning is made easy. Furthermore, different types of insulating layers may be overlapped.

When transparent materials are used for all of the electrodes, semiconductors, and insulating layers as described above, the entire TFT circuit becomes transparent, whereby the numerical aperture is increased. Meanwhile, photolithography is used for patterning of the electrodes, the semiconductors, and the insulating layers. In general, the photolithography process is carried out at 120° C. or lower that is several tens degree lower than in etching.

An organic EL layer is formed on a pixel electrode. Generally, a lamellar structure of a hole transport layer, a light emitting layer, or the like is used as the organic EL layer. The organic EL is sometimes abbreviated to the OLED (organic light-emitting diode).

Examples of a material that composes the hole transport layer include conductive high-molecular materials, such as polyaniline derivatives, polythiophene derivatives, polyvinyl carbazole derivatives, and a mixture of poly(3,4-ethylene dioxythiophene) and polystyrene sulfonate (PEDOT:PSS).

The hole transport materials may be dissolved or dispersed in a single or mixed solvent of toluene, xylene, acetone, methyl ethyl ketone, methyl isobutyl ketone, cyclohexanone, methanol, ethanol, isopropyl alcohol, ethyl acetate, butyl acetate, water, and the like, and applied by a coating method such as spin coating, bar coating, wire coating, or slit coating. In addition, patterning may be carried out if necessary.

According to necessity, a surfactant, an oxidization inhibitor, a viscosity adjuster, an ultraviolet absorbent, or the like may be added to the hole transport layer. The thickness of the hole transport layer is preferably in a range of from 10 nm to 200 nm. Alternately, a low-molecular material such as triphenyldiamine (TPD) or a-NPD (bis[N-naphthyl-N-phenyl]benzidine) may be used.

The light-emitting layer is laminated on the hole transport layer. The light-emitting layer is not limited to a single layer structure, and may have a multilayer structure further provided with an electric charge transport layer and the like. For the light-emitting layer, for example, an organic light-emitting material soluble in an organic solvent, such as a coumarin-based, perylene-based, pyran-based, anthrone-based, porphyrin-based, quinacridone-based, N,N′-dialkyl-substituted quinacridone-based, naphthalimide-based, N,N′-diaryl-substituted pyrrolopyrrole-based, iridium complex-based material, and a material obtained by dispersing the organic light-emitting material in a polymer such as polystyrene, polymethyl methacrylate, or polyvinyl carbazole; or a polyarylene-based, polyarylene vinylene-based, or polyfluorene-based high-molecular fluorescent material, may be used.

The high-molecular fluorescent material may be dissolved in a single or mixed solvent of toluene, xylene, acetone, methyl ethyl ketone, methyl isobutyl ketone, cyclohexanone, methanol, ethanol, isopropyl alcohol, ethyl acetate, butyl acetate, water, and the like, and applied by a coating method such as spin coating, bar coating, wire coating, or slit coating. In addition, the light-emitting layer may also be formed by a printing method.

In addition, according to necessity, a surfactant, an oxidization inhibitor, a viscosity adjuster, an ultraviolet absorbent, or the like may be added to the high-molecular fluorescent material layer.

The thickness of the light-emitting layer is preferably 1,000 nm or lower, and more preferably in a range of from 50 nm to 150 nm, in the case of a single layer or a multilayer structure.

As other materials, low-molecular fluorescent materials that have quinacridone, a coumarin derivative, a rubrene, 4-(dicyanomethylene)-2-methyl-6-(p-dimethylaminostyryl)-4H-pyran (DCM) derivative, perylene, an iridium complex, or the like doped in an alumiquinoline complex, distyryl derivative, or the like may be used.

The color of light emitted by the low-molecular fluorescent material is determined by the material itself or a dopant, and materials that have a styrylarylene derivative or styrylamine derivative doped in a distyrylarylene derivative, or the like are used to emit blue light; an alumiquinoline complex or the like is used to emit green light; materials that have DCM doped in an alumiquinoline complex are used to emit red light; and structures in which a blue light-emitting material and a yellow to orange light-emitting material are laminated, and the like are used to emit white light. On the other hand, the color of light emitted by the high-molecular fluorescent material may be adjusted by changing the side chain, and polymers that have the same basic skeleton may be used for RGB. In addition, white light-emitting may be achieved by mixing the above.

In a case in which the organic EL layer employs an RGB color-coding method, mask deposition is carried out in the case of the low-molecular light-emitting layer, and it is difficult to carry out uniform color-coding in a large area. In the case of the high-molecular light-emitting layer, the printing method may be used, and uniform color-coding is carried out in a large area. As the printing method, ink jet printing, reverse printing, flexo printing, or the like may be used. Particularly, uniform printing may be carried out in a large area in a short time by flexo printing, flexo printing is most preferable. Meanwhile, the substrate temperature may be room temperature even for mask deposition, and the printing methods, such as ink jet, reverse printing, flexo printing, and the like.

Materials that have the corresponding light-emitting characteristics of the organic EL layer may be used for the common electrodes, and examples of the materials usable in the invention include pure metals such as lithium, magnesium, calcium, ytterbium, or aluminum, alloys thereof, and alloys of the above metals and a stable metal such as gold or silver. The materials may be provided by the ordinary vacuum deposition method, such as resistance heating and EB heating, and the film thickness is not particularly limited, but is preferably in a range of from 1 nm to 500 nm. In addition, a thin film of lithium fluoride or the like may be provided between the anode layer and the light-emitting layer. Furthei more, a protective layer made of an insulating inorganic material, resin, or the like may be provided on the anode layer. Even in the above process, the substrate temperature may be room temperature.

Since the image display apparatus of the invention has the color filter of the invention, a high transmittance and favorable color reproducibility are achieved.

The organic light-emitting element in the image display apparatus of the invention is not limited to the above embodiments as long as the organic light-emitting element is an organic EL light-emitting element that has the above light-emitting characteristics. The excellent effects of the invention are still exhibited even in a case in which, for example, the organic EL light-emitting element and a color filter layer that contains the specific pigment of the invention are combined so as to have a macro cavity structure and a wavelength of the maximum light-emitting intensity in a range of 500 nm to 600 nm.

### EXAMPLE 1

Hereinafter, the invention will be more specifically described by referring to examples, but the invention is not limited to the following examples, unless departing from the gist of the invention. Meanwhile, “parts” are based on mass unless otherwise noted.

### EXPERIMENT EXAMPLE

### Preparation of Pigment Dispersion Composition YG-1

The components in the following formulation were mixed, and stirred and mixed using a homogenizer at a rotation speed of 3,000 rpm for 3 hours, thereby preparing a mixed solution including a pigment.

### Formulation

| | |
|---|---|
| Pigment Yellow 185 | 125 parts |
| Phthalocyanine derivative | 5 parts |
| (SOLSPERSE 3000, manufactured by the Lubrizol Japan | |
| Limited) | |
| Propylene glycol monomethyl ether acetate solution of benzyl | 15 parts |
| methacrylate/methacrylic acid (=70/30 [molar ratio]) | |
| copolymer (Mw: 5,000) (solid content 50%) | |
| Dispersant (DISPERBYK-161, manufactured by BYK | 60 parts |
| Japan K.K.) | |
| Propylene glycol monomethyl ether acetate | 795 parts |

Subsequently, the mixed solution obtained in the above manner was additionally subjected to a dispersion treatment for 12 hours with a beads disperser DISPERMAT (manufactured by Getzmann GmbH) in which 0.3 mmφ zirconia beads were used. After that, a dispersion treatment was carried out under a pressure of 2,000 kg/cm³ and a flux of 500 g/min using a depressurization mechanism-equipped high-pressure disperser NANO-3000-10 (manufactured by Nihon B.E.E. Co., Ltd.). The dispersion treatment (the dispersion treatment in which NANO-3000-10 was used) was repeated ten times, thereby producing a pigment dispersion composition YG-1.

Preparation of Pigment Dispersion Compositions YG-2, CG-1, CG-2, CG-3, and CG-4

Pigment dispersion compositions YG-2, CG-1, CG-2, CG-3, and CG-4 were prepared in the same manner except that the “Pigment Yellow 185” that was used to prepare pigment dispersion composition YG-1 was changed to “Pigment Yellow 150” (YG-2), “Pigment Green 7” (CG-1), “Pigment Green 36” (CG-2), “the aluminum phthalocyanine pigment represented by the structural formula (II) as described in paragraph [0021] of JP-A No. 2004-333817” (CG-3), and “Pigment Green 58” (CG-4), respectively.

The components in the following formulation were further added to the obtained pigment dispersion composition YG-1, stirred and mixed, thereby preparing a photocurable composition CMYG-1 (color resist solution).

The solid content concentration of the thus-obtained photocurable composition CMYG-1 was 24.1% by mass. In addition, the concentration of the pigment in the total solid content of the obtained photocurable composition CMYG-1 was 30.0% by mass.

Formulation

| | |
|---|---|
| Pigment dispersion composition YG-1 | 100 parts |
| Propylene glycol monomethyl ether acetate solution of | 12 parts |
| benzyl methacrylate/methacrylic acid (=70/30 [mole | |
| ratio]) copolymer (Mw: 30,000) (solid content: 50%) | |
| DPHA (manufactured by Nippon Kayaku Co., Ltd.) | 12 parts |
| (dipentaerythritol pentacrylate) | |
| 2-(o-Chlorophenyl)-4,5-diphenylimidazolyl dimer | 3 parts |
| (photopolymerization initiator) | |
| 4,4′-Bis(diethylamino)benzophenone (sensitizing | 4.5 parts |
| colorant) | |
| 2-Mercaptobenzothiazole (hydrogen-donating compound) | 2 parts |
| Polymerization inhibitor: p-methoxy phenol | 0.001 parts |
| Fluorine-containing surfactant (product name: | 0.5 parts |
| MEGAFAC R08, manufactured by DIC Corporation) | |
| Propylene glycol monomethyl ether acetate | 61 parts |

Manufacture of Single-Color Pigment Color Filter Using Photocurable Composition CMYG-1

After the photocurable composition CMYG-1 (color resist solution) obtained in the above manner was applied by slit-coating on a 550 mm×650 mm glass substrate under the conditions described below, the substrate was left stand for 10 minutes as it was, and then subjected to vacuum drying and prebaking (dried for 60 seconds in an oven at 90° C.).

In this way, a color filter (PY185) having a colored area that included only Pigment Yellow 185, which is a pigment, as a colorant was produced.

Slit Coating Conditions

Gap in aperture section at the tip of coating head: 50 μm

Coating speed: 100 mm/second

Clearance between substrate and coating head: 150 μm

Coating thickness (dry thickness): 2.2 μm

Coating temperature: 23° C.

Preparation of Photocurable Compositions CMYG-2, CMCG-1, CMCG-2, CMCG-3, and CMCG-4 and Manufacture of Single-Color Pigment Color Filters Using the Same

Photocurable compositions CMYG-2, CMCG-1, CMCG-2, CMCG-3, and CMCG-4 were prepared in the same manner except that “pigment dispersion composition YG-1” that was used to prepare the photocurable composition CMYG-1 was changed to the “pigment dispersion composition YG-2”, “pigment dispersion composition CG-1”, “pigment dispersion composition CG-2”, “pigment dispersion composition CG-3”, and “pigment dispersion composition CG-4”, respectively.

After that, a color filter (PY150), a color filter (PG7), a color filter (PG36), a color filter (aluminum phthalocyanine), and a color filter (PG58) were manufactured by the same method as the method of manufacturing the color filter (PY185) except that the thus-ontained photocurable compositions were used, respectively.

Manufacture of Single-Color Dye Color Filters Using Photocurable Compositions

Photocurable compositions CMY1, CMY5, CMY6, CMY7, CMY8, CMY9, and CMC1 were prepared in the same manner except that “pigment dispersion composition YG-1” that was used for preparation of the photocurable composition CMYG-1 was changed to “a cyclohexanone solution containing dye Y-1 at 12.5% by mass”, “a cyclohexanone solution containing dye Y-5 at 12.5% by mass”, “a cyclohexanone solution containing dye Y-6 at 12.5% by. mass”, “a cyclohexanone solution containing dye Y-7 at 12.5% by mass”, “a cyclohexanone solution containing dye Y-8 at 12.5% by mass”, “a cyclohexanone solution containing dye Y-9 at 12.5% by mass”, and “a cyclohexanone solution containing dye C-1 at 12.5% by mass”, respectively.

Furthermore, a color filter (Y-1), a color filter (Y-5), a color filter (Y-6), a color filter (Y-7), a color filter (Y-8), a color filter (Y-9), and a color filter (C-1) were manufactured by the same method as the method of manufacturing the color filter (PY185), except that the thus-obtained photocurable compositions were used, respectively.

The structures of dyes Y-1, Y-5, Y-6, Y-7, Y-8, Y-9, and C-1 that were used for manufacturing the single-color dye color filters will be hereinafter shown.

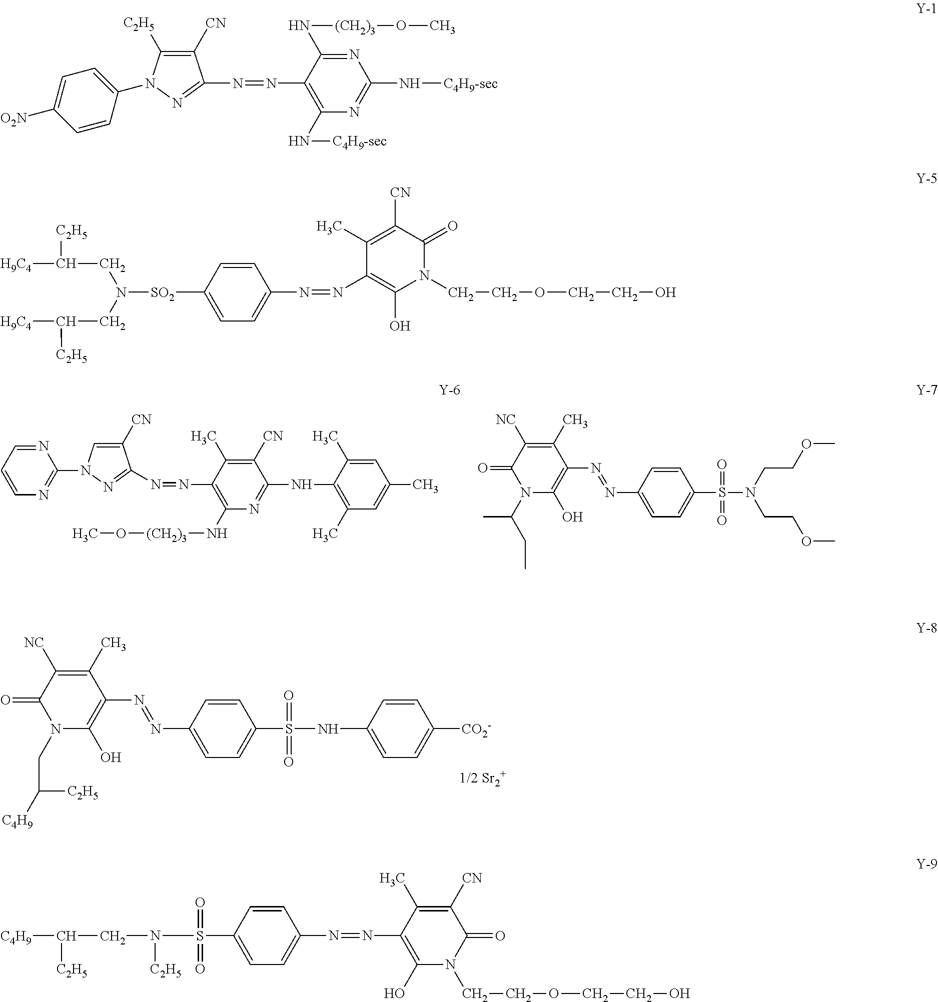

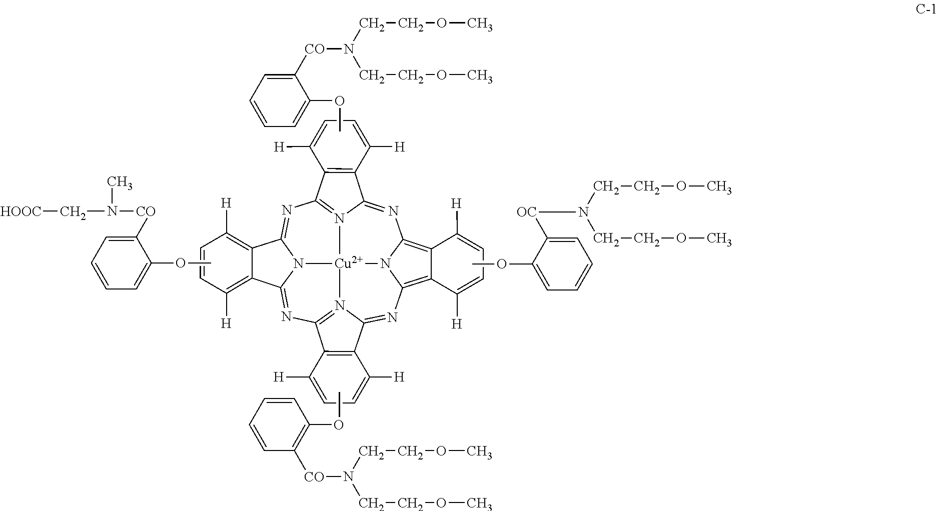

Measurement of Spectral Absorption Spectrum

Spectral absorption spectrums were measured using MCPD-2000 (manufactured by Otsuka Electronics Co., Ltd.) for each of the single-color pigment color filters and single-color dye color filters which were obtained as described above.

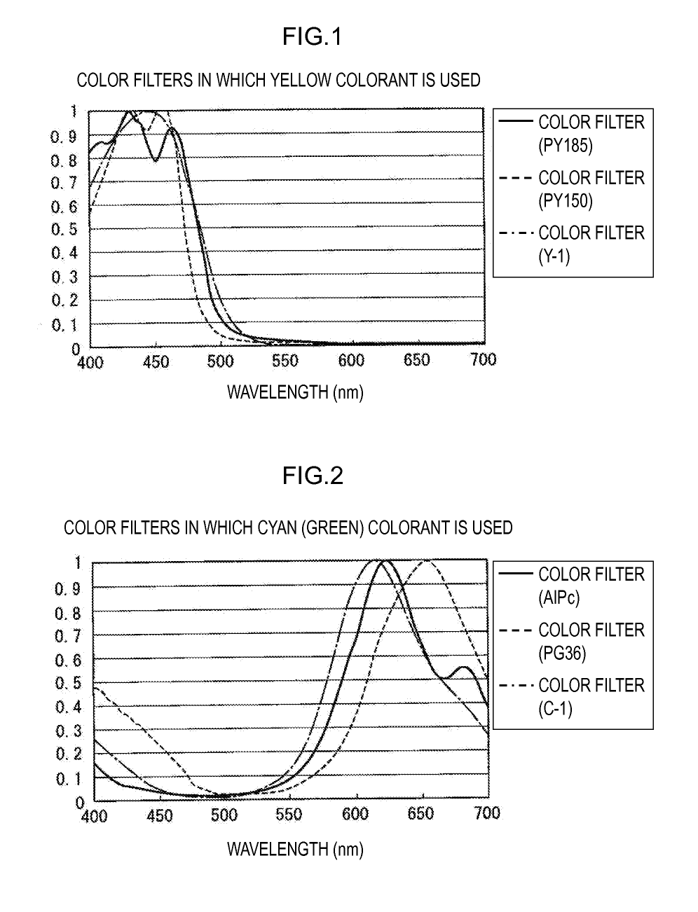

Typical spectral absorption spectrums are shown in FIG. 1 (yellow colorants) and FIG. 2 (cyan (green) colorants).

It is found from the results shown in FIGS. 1 and 2 that the optical density was low in the vicinity of the lowest density (wavelength of from 510 nm to 600 nm in a case of a yellow colorant, and wavelength of from 450 nm to 515 nm in a case of a cyan (green) colorant) in the green light area for all of the single-color color filters manufactured using only dyes.

Meanwhile, the same tendency was observed in the color filters not shown in FIGS. 1 and 2.

### EXAMPLES A1 to A11 AND COMPARTIVE EXAMPLES A1 TO A3

### Manufacture of Single-Color Color Filters

Based on the results of the experimental examples, photocurable compositions were prepared using the pigment dispersion composition and/or dye solution which were used for manufacturing the photocurable compositions in the experimental examples, while the amounts of the pigment dispersion composition and dye solution to be used, and the usage proportions thereof were adjusted so as that the green light area G satisfies the NTSC standard values of the CIE standard when a C light source is used.

Color filters CF-A1 to CF-A3 (Comparative Examples A1 to A3) and CF-A4 to CF-A14 (Examples A1 to A11) were manufactured by the same method as the method of manufacturing the color filter (PY185) in the experimental example, except that the thus-obtained photocurable compositions were used, respectively.

The types of pigments and dyes which were used in the manufactured color filters CF-A1 to CF-A14 and the usage amounts of the pigments and dyes are shown in Table 1 shown below. In addition, the differences in spectral absorption maximum peak wavelength of the pigments and dyes which were used in the color filters CF-A1 to CF-A14 are also shown in Table 1.

Evaluation of Color Filters

A simple display apparatus that transmits a C light source to the manufactured color filters CF-A1 to CF-A14 was produced. A luminance colorimeter (manufactured by Topcon Corporation, BM-5A) was disposed in the normal line direction with respect to the display apparatus, the chromaticity (x value, y value) and the luminance (cd/m²) were measured when the color filters were used, and the results are shown in Table 2 as the relative values with respect to the results of color filter CF-A2.

In addition, for evaluation of the heat resistance, the color filters CF-A1 to CF-A14 were subjected to a heating treatment (post-baking) for 1 hour in an oven at 220° C., the spectrums before and after the heating were measured using MCPD-2000 (manufactured by Otsuka Electronics Co., Ltd.), and the changes in maximum density value were used as the index of the heat resistance.

The results are shown in Table 1.

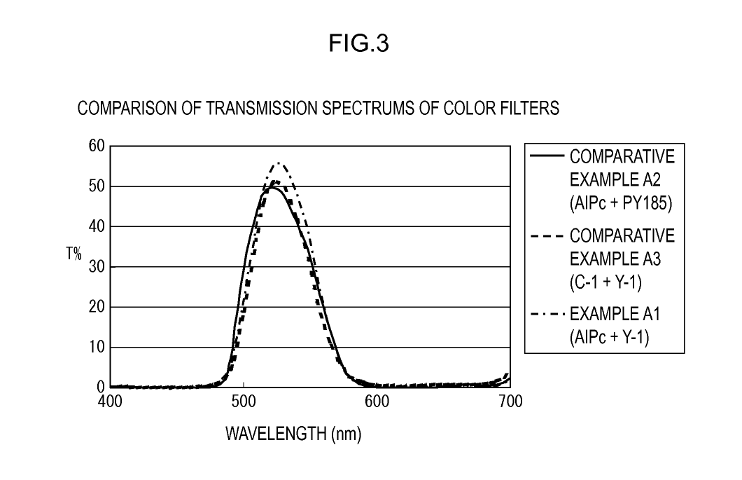

Furthermore, transmission spectrums were measured using MCPD-2000 (manufactured by Otsuka Electronics Co., Ltd.) for the manufactured color filters CF-A1 to CF-A14. The transmission spectrums of color filters CF-A2 (Comparative Example A2), CF-A3 (Comparative Example A3), and CF-A4 (Example A1) are shown in FIG. 3 as representative examples of the results.

TABLE 1

| | | Formulation (usage amount: g/m²) | | | Evaluation results | | |
|---|---|---|---|---|---|---|---|
| | | Cyan (green) | | Difference in spectral absorption | | Relative | Heat |
| | Color filter | colorant | Yellow colorant | maximum peak wavelength (nm) | Hue (x, y) | luminance | resistance |
| Comparative | CF-A1 | PG36 | PY150 | 225 | Target hue cannot be achieved | | |
| Example A1 | | (—) | (—) | | | | |
| Comparative | CF-A2 | Aluminum | PY185 | 195 | (0.21, 0.71) | 100 | 0.01 |
| Example A2 | | phthalocyanine | (0.51) | | | | |
| | | (0.51) | | | | | |
| Comparative | CF-A3 | C-1 | Y-1 | 210 | (0.21, 0.71) | 95 | 0.54 |
| Example A3 | | (0.57) | (0.69) | | | | |
| Example A1 | CF-A4 | Aluminum | Y-1 | 180 | (0.21, 0.71) | 120 | 0.03 |
| | | phthalocyanine | (0.63) | | | | |
| | | (0.39) | | | | | |
| Example A2 | CF-A5 | PG36 | Y-5 | 160 | (0.21, 0.71) | 125 | 0.01 |
| | | (0.53) | (0.58) | | | | |
| Example A3 | CF-A6 | PG7 | Y-6 | 220 | (0.21, 0.71) | 109 | 0.02 |
| | | (0.40) | (0.80) | | | | |
| Example A4 | CF-A7 | Aluminum | Y-5 | 160 | (0.21, 0.71) | 112 | 0.02 |
| | | phthalocyanine | (0.65) | | | | |
| | | (0.36) | | | | | |
| Example A5 | CF-A8 | Aluminum | Y-6 | 215 | (0.21, 0.71) | 110 | 0.02 |
| | | phthalocyanine | (0.80) | | | | |
| | | (0.43) | | | | | |
| Example A6 | CF-A9 | PG36 | Y-1 | 210 | (0.21, 0.71) | 115 | 0.03 |
| | | (0.53) | (0.80) | | | | |
| Example A7 | CF-A10 | PG7 | Y-1 | 185 | (0.21, 0.71) | 130 | 0.02 |
| | | (0.38) | (0.80) | | | | |
| Example A8 | CF-A11 | PG7 | Y-5 | 165 | (0.21, 0.71) | 128 | 0.01 |
| | | (0.40) | (0.80) | | | | |
| Example A9 | CF-A12 | PG58 | Y-7 | 230 | (0.21, 0.71) | 108 | 0.02 |
| | | (0.38) | (0.62) | | | | |
| Example A10 | CF-A13 | PG58 | Y-8 | 235 | (0.21, 0.71) | 110 | 0.02 |
| | | (0.58) | (0.45) | | | | |
| Example A11 | CF-A14 | PG58 | Y-9 | 230 | (0.21, 0.71) | 107 | 0.02 |
| | | (0.72) | (0.26) | | | | |

As shown in Table 1 and FIG. 3, the following was found.

That is, the color filter CF-Al of Comparative Example Al was a color filter manufactured using a photocurable composition containing a general pigment that has been used in green color filters for conventional liquid crystals, but when the color filter CF-Al was used, a chromaticity of the NTSC standard value was not be able to be achieved using a broad light source such as C light source.

In contrast, by selecting the type of pigment as in the color filter CF-A2 of the Comparative Example A2, the target chromaticity was able to be achieved, the luminance thereof was inferior to those of the color filters CF-A4 to CF-A14 of Examples Al to All.

Furthermore, it is found that, in the color filter CF-A3 of Comparative Example A3 which was manufactured using only a dye, as shown in FIGS. 1 and 2, although the optical density of the G area containing only the dye was low, a higher transmittance was not able to be attained when the chromaticity of the NTSC standard value was attempted to be achieved, as compared to the color filter CF-A2 that was manufactured using only the pigment. In addition, it is found that the luminance of the color filter CF-A3 was inferior to that of the color filter CF-A2. Furthermore, since only the dye was used as the colorant in the color filter CF-A3, a significant decrease in optical density was observed before and after heating, and the heat resistance is low.

It is found that, all of color filters CF-A4 to CF-A14 of the invention which were manufactured by including both the specific yellow dye and a green pigment or cyan pigment had a high luminance at the target chromaticity. It is found that, as is clear from FIG. 3, an extremely high transmittance was able to be obtained in the color filters manufactured by including both the specific yellow dye and a green pigment or cyan pigment.

Furthermore, it is found that the color filters CF-A4 to CF-A14 had a heat resistance that is approximately the same or comparable level as that of the color filter CF-A2 containing the pigment singly. The effect cannot be explained only with a reason that the amount of the dye used in the green colored area was reduced, and, it became possible to provide a color filter that satisfies both color reproduction and luminance, and has no problem with the heat resistance.

### EXAMPLES B1 TO B11 AND COMPARATIVE EXAMPLES B1 TO B3

### Manufacture of Liquid Crystal Display Apparatus

Color filters CF-B 1 to CF-B3 (Comparative Example B1 to Comparative Example B3) and CF-B4 to CF-B14 (Example B1 to Example B11) were manufactured by the following method. Liquid crystal display apparatuses LCD-B1 to LCD-B14 were manufactured using the color filters, and the display characteristics thereof were evaluated.

Manufacture of Red-Colored Photosensitive Resin Composition R

A pigment dispersion composition that has the following formulation was prepared, and a dispersion treatment was carried out in the same manner as in the manufacture of the pigment dispersion composition YG-1, thereby producing a red pigment dispersion R1.

### [Formulation of Red Pigment Dispersion R1]

| | |
|---|---|
| Pigment Red 254 | 75 parts |
| Pigment Red 177 | 50 parts |
| Benzyl methacrylate/methacrylic acid copolymer | 70 parts |
| (copolymerization ratio: 70/30, weight average molecular | |
| weight: 30,000, acid value: 40) | |
| Propylene glycol monomethyl ether acetate | 800 parts |

The components of the following formulation were further added to the thus-obtained pigment dispersion R1, thereby producing a red-colored photosensitive resin composition R.

### [Formulation of Red-Colored Photosensitive Resin Composition R]

| | |
|---|---|
| Red pigment dispersion R1 | 100 parts |
| Propylene glycol monomethyl ether acetate solution of | 12 parts |
| benzyl methacrylate/methacrylic acid (=70/30 [molar | |
| ratio]) copolymer (Mw: 30,000) (solid content 50%) | |
| DPHA (manufactured by Nippon Kayaku Co., Ltd.) | 12.1 parts |
| 2-(o-chlorophenyl)-4,5-diphenylimidazolyl dimer | 3.1 parts |
| (photopolymerization initiator) | |
| 4,4′-bis(diethylamino)benzophenone (sensitizing | 4.2 parts |
| colorant) | |
| 2-mercaptobenzothiazole (hydrogen-donating compound) | 2.1 parts |
| Polymerization inhibitor: p-methoxy phenol | 0.001 parts |
| Fluorine-containing surfactant (product name: | 0.5 parts |
| MEGAFAC R08, manufactured by DIC Corporation) | |
| Propylene glycol monomethyl ether acetate | 60 parts |

Manufacture of Red-Colored Photosensitive Resin Composition B

A red-colored photosensitive resin composition B was manufactured in the same manner except that Pigment Red 254 used in the manufacture of the red-colored photosensitive resin composition R was changed to 113 parts of Pigment Blue 15:6, and Pigment Red 177 was changed to 12 parts of Pigment violet 23.

Manufacture of Black-Colored Photosensitive Resin Composition K

A pigment dispersion composition that has the following formulation was prepared, and a dispersion treatment was carried out in the same manner as in the manufacture of the red pigment dispersion R1, thereby manufacturing a black pigment dispersion K1.

### [Formulation of Black Pigment Ddispersion K1]

| | |
|---|---|
| Carbon black (product name: NIPEX35, | 13.1 parts |
| manufactured by Evonik Degussa Japan Co., Ltd.) | |
| Polymer (random copolymer having a molar ratio of | 6.7 parts |
| benzyl methacrylate/methacrylic acid = 72/28, | |
| molecular weight: 37,000) | |
| Propylene glycol monomethyl ether acetate | 79.1 parts |
| Dispersant (the compound shown below) | 0.65 parts |

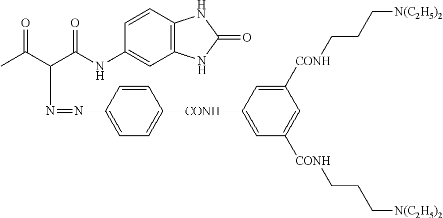

A black-colored photosensitive resin composition K having the following formulation was prepared using the black pigment dispersion

### [Formulation of Black-Colored Photosensitive Resin Composition K]

| | |
|---|---|
| Black pigment dispersion K1 | 25 parts |
| Propylene glycol monomethyl ether acetate | 8.5 parts |
| Methyl ethyl ketone | 53 parts |
| Binder (mixture of 27 parts of a polymer | 9.1 parts |

(random copolymer having a molar ratio of benzyl
methacrylate/methacrylic acid = 78/22, molecular weight:
38,000) and 73 parts of propylene glycol monomethyl
ether acetate)

| | |
|---|---|
| Hydroquinone monomethyl ether | 0.002 parts |
| DPHA (manufactured by Nippon Kayaku Co., Ltd.) | 12 parts |
| 2,4-bis(trichloroethyl)-6-[4′-(N,N-bisethoxycarbonyl- | 0.16 parts |

methyl)amino-3′-bromophenyl]-s-triazine

| | |
|---|---|
| 30 mass % Methyl ethyl ketone solution of surfactant | 0.042 parts |

(the compound shown below)

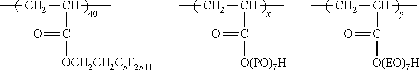

(n = 6, x = 55, y = 5,
Mw = 33.940, Mw/Mn = 2.55
PO: propylene oxide, EO: ethylene oxide)

Formation of Color Filter

### Formation of Black Matrix

An alkali-free glass substrate was washed with an UV washing apparatus, and then washed with a brush using a washing agent, followed by ultrasonic washing using ultrapure water. The substrate was subjected to a heat treatment at 120° C. for 3 minutes so as to stabilize the surface state, and then the substrate was cooled so that the temperature was adjusted to 23° C.

The substrate was coated with the black-colored photosensitive resin composition K using a coater for glass substrates having a slit-shaped nozzle (manufactured by F. A. S Asia Co., Ltd., product name: MH-1600). Subsequently, part of the solvent was dried for 30 seconds using a VCD (vacuum drying apparatus, manufactured by Tokyo Ohka Kogyo Co., Ltd.) so as to eliminate the fluidity of the coated layer, and then prebaking was carried out at 120° C. for 3 minutes, thereby producing a 2.4 μm-thick black photosensitive resin layer.

Pattern light exposure was performed using a proximity exposure apparatus equipped with an ultrahigh pressure mercury lamp (manufactured by Hitachi High-technologies Corporation) at an exposure amount of 300 mJ/cm² in a state in which the substrate and a mask (quartz exposure mask having an image pattern) were made to stand vertically with a distance between the exposure mask surface and the photosensitive resin layer set to 200 μm.

Next, pure water was sprayed using a shower nozzle so that the surface of the black photosensitive resin layer was uniformly wet. After that, shower development was carried out at 23° C. for 80 seconds with a flat nozzle pressure of 0.04 MPa using a KOH-based developer (KOH, containing a nonionic surfactant, product name: CDK-1, manufactured by Fuji Film Electronics Materials), thereby producing a patterning image. Subsequently, ultrapure water was sprayed at a pressure of 9.8 MPa using a ultrahigh pressure washing nozzle so as to remove residues, thereby producing a black (K) image K. Finally, a heat treatment was carried out at 220° C. for 30 minutes, thereby fanning a black matrix.

Formation of RGB Pixels

A red-colored photosensitive resin composition R, the green-colored photosensitive resin composition (the resin composition used in the manufacture of CF-A1 to CF-A14 of the example A), and a blue-colored photosensitive resin composition B were sequentially laminated and patterned on the glass substrate having the black matrix formed thereon, respectively, by the same processes as in the formation of the black matrix, thereby obtaining a color filter having three color pixels of RGB. In this case, the thicknesses of the colored portions of RGB were 1.6 μm respectively. The respective filters were referred to as “CF-B1” to “CF-B 14”, according to the green-colored photosensitive resin compositions used.

Formation of ITO Electrodes

The glass substrate having the color filters formed thereon was put in a sputtering apparatus, and ITO was deposited in a 1300 Å-thick on the entire surface at 100° C. Thereafter, annealing was carried out at 240° C. for 90 minutes to crystallize the ITO, thereby forming an ITO transparent electrode.

Formation of Spacer

A spacer was formed on the ITO transparent electrode manufactured in the above manner, by the same method as the method for forming a spacer as described in “Example 1” of JP-A No. 2004-240335.

Formation of Protrusions for Controlling Liquid Crystal Orientation

Protrusions for controlling liquid crystal orientation were formed on the ITO transparent electrode having the spacer foi Hied thereon, using the following coating solution for a positive-working photosensitive resin layer.

Provide that the following methods were used for the exposure, development, and baking processes.

A proximity exposure apparatus (manufactured by Hitachi High-technologies Corporation) was disposed so that the distance of a predetermined photomask from the surface of the photosensitive rein layer became 100 μm, and proximity exposure was carried out through the photomask using an ultrahigh pressure mercury lamp with an irradiation energy of 150 mJ/cm².

Subsequently, development was carried out while a 2.38% tetramethyl ammonium hydroxide aqueous solution was sprayed on the substrate at 33° C. for 30 seconds using a shower-type developing apparatus. In this manner, unnecessary portions (exposure portions) in the photosensitive resin layer were removed by the development, whereby a substrate for liquid crystal display apparatuses was prodced, in which protrusions for controlling liquid crystal orientation which were formed from a photosensitive resin layer and were patterned into a desired shape, were foinied on the color filter side of the substrate.

Next, the substrate for liquid crystal display apparatuses that has the protrusions for controlling liquid crystal orientation was baked at 230° C. for 30 minutes, thereby forming cured protrusions for controlling liquid crystal orientation on the substrate for liquid crystal display apparatuses.

Prescription of Positive-Working Photosensitive Resin Layer

| | |
|---|---|
| Positive-working resist solution (FH-2413F, manufactured | 53.0 parts |
| by Fuji Film Electronics Materials) | |
| Methyl ethyl ketone | 46.5 parts |
| MEGAFAC F-780F (manufactured by DIC Corporation) | 0.05 parts |

Manufacture of Liquid Crystal Display Apparatus

An oriented film fomed from polyimide was further provided on the substrate for liquid crystal display apparatuses which was obtained as described above. After that, an epoxy resin sealing agent was printed at a position corresponding to the black matrix outer frame provided around the pixels of the color filters so as to surround the pixels, and MVA mode liquid crystal was dropped. Then, the substrate was attached to a facing substrate, followed by a heat treatment, thereby curing the sealing agent.

Polarization plates HLC2-2518 (manufactured by Sanritz Corporation) were attached to both surfaces of the liquid crystal cell obtained in this manner. Next, an LED light source (the backlight source of KDL-40ZX1, liquid crystal television manufactured by SONY Corporation) was disposed at a side that is the rear surface of the liquid crystal cell provided with the polarization plates as a light source, thereby producing a liquid crystal display (LCD) apparatus. The display apparatuses were referred to as “LCD-B1” to “LCD-B 14”, according to the color filters CF-B1 to CF-B14 used.

Evaluation of Display Apparatuses

The image characteristics of LCD-B1 to LCD-B 14 were evaluated by a sensory test method. Specifically, 10 examinees were selected and asked to evaluate image qualities of several kinds of still images, such as color stripe images, displayed on LCD-B1 to LCD-B14. In this case, the evaluation was carried out while both the examiners and examinees did not know the kind of the display apparatus under evaluation.

For the evaluation, the examinees were asked to give scores of 14 to 1 to the display apparatuses based on the image qualities from good to bad, and the evaluation was defined by the total points by the ten examinees. The following Table 2 shows the results.

TABLE 2

| | | Formulation | | |
|---|---|---|---|---|
| | Display | Cyan (green) | Yellow | |
| | apparatus | colorant | colorant | Evaluation |
| Comparative | LCD-B1 | PG36 | PY150 | 14 |
| Example B1 | | | | |
| Comparative | LCD-B2 | Aluminum | PY185 | 36 |
| Example B2 | | phthalocyanine | | |
| Comparative | LCD-B3 | C-1 | Y-1 | 30 |
| Example B3 | | | | |
| Example B1 | LCD-B4 | Aluminum | Y-1 | 108 |
| | | phthalocyanine | | |
| Example B2 | LCD-B5 | PG36 | Y-5 | 120 |
| Example B3 | LCD-B6 | PG7 | Y-6 | 58 |
| Example B4 | LCD-B7 | Aluminum | Y-5 | 74 |
| | | phthalocyanine | | |
| Example B5 | LCD-B8 | Aluminum | Y-6 | 68 |
| | | phthalocyanine | | |
| Example B6 | LCD-B9 | PG36 | Y-1 | 114 |
| Example B7 | LCD-B10 | PG7 | Y-1 | 126 |
| Example B8 | LCD-B11 | PG7 | Y-5 | 128 |
| Example B9 | LCD-B12 | PG58 | Y-7 | 58 |
| Example B10 | LCD-B13 | PG58 | Y-8 | 60 |
| Example B11 | LCD-B14 | PG58 | Y-9 | 56 |

As is apparent from Table 2, as a whole, the LCD display apparatuses of Examples B1 to B11 having the color filters of the invention were able to obtain favorable image quality evaluation.

In the examples, the image quality evaluation was carried out on MVA mode liquid crystal display apparatuses, but it is considered that the color filter of the invention having a high luminance is capable of contributing to improvement of image qualities even in liquid crystal display apparatuses of other modes or in color filter-type organic EL displays.

1. A color filter, comprising:
a substrate; and
a green colored area which is provided on the substrate and which comprises a green pigment or cyan pigment, and at least one yellow dye selected from the group consisting of the following (1) to (3):
(1) a methine dye having a pyrazolotriazole ring in a structure thereof;
(2) an azo dye having a pyridone ring in a structure thereof; and
(3) an azo dye having a pyrazole ring in a structure thereof.

2. The color filter according to claim 1, wherein the (1) methine dye having a pyrazolotriazole ring in a structure thereof is a compound represented by the following formula (Ia) or (Ib): 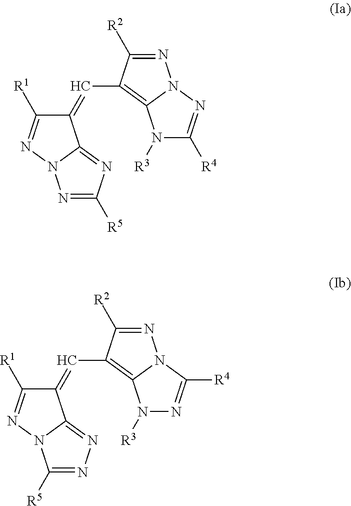
wherein, in formulae (Ia) and (Ib), R¹ to R⁵ each independently represent a hydrogen atom or a monovalent substituent.

3. The color filter according to claim 2, wherein, in formula (Ia) or (Ib), the monovalent substituent represented by R¹ to R⁵ is an alkyl group, an aryl group, a perfluoroalkyl carbonyl group, an alkylsulfonyl group, an alkenylsulfonyl group, an arylsulfonyl group, a heterocyclic sulfonyl group, a sulfamoyl group, an alkylsulfamoyl group, an arylsulfamoyl group, or a heterocyclic sulfamoyl group, and each of the groups may further have a substituent.

4. The color filter according to claim 2, wherein, in formula (Ia) or (Ib), R¹ and R² are each a straight-chain alkyl group or a branched alkyl group; R⁴ and R⁵ are each an alkyl group or an aryl group; and R³ is a hydrogen atom, an alkyl group, or an aryl group.

5. The color filter according to claim 1, wherein the (2) azo dye having a pyridone ring in a structure thereof is a compound represented by the following formula (II): 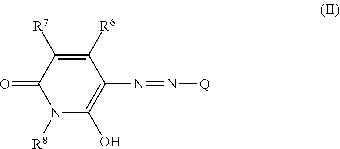
wherein, in formula (II), R⁶ and R⁷ each independently represent a hydrogen atom or a monovalent substituent; R⁸ represents a hydrogen atom, an aliphatic group, an aryl group, a heterocyclic group, a carbamoyl group, an aliphatic carbonyl group, an aryloxycarbonyl group, an acyl group, an aliphatic sulfonyl group, an arylsulfonyl group, or a sulfamoyl group; Q represents a diazo component residual; and colorants represented by formula (II) may form a polymer of dimer or higher at arbitrary positions.

6. The color filter according to claim 1, wherein, in formula (II), the monovalent substituent represented by R⁶ or R⁷ is a halogen atom, an aliphatic group, an aryl group, a heterocyclic group, a cyano group, a carboxyl group, a carbamoyl group, an aliphatic oxycarbonyl group, an aryloxycarbonyl group, an acyl group, a hydroxyl group, an aliphatic oxy group, an aryloxy group, an acyloxy group, a carbamoyl oxy group, a heterocyclic oxy group, an amino group, an aliphatic amino group, an arylamino group, a heterocyclic amino group, an acyl amino group, a carbamoyl amino group, a sulfamoyl amino group, an aliphatic oxycarbonylamino group, an aryloxycarbonylamino group, an aliphatic sulfonyl amino group, an arylsulfonyl amino group, a nitro group, an aliphatic thio group, an arylthio group, an aliphatic sulfonyl group, an arylsulfonyl group, a sulfamoyl group, a sulfo group, an imide group, or a heterocyclic thio group.

7. The color filter according to any one of claims 1 to 6 claim 1, wherein a difference in spectral absorption maximum peak wavelength between the green pigment or cyan pigment and at least one yellow dye selected from the group consisting of (1) to (3) in a visible light range is 130 nm or more.

8. The color filter according to claim 1, wherein a difference in spectral absorption maximum peak wavelength between the green pigment or cyan pigment and at least one yellow dye selected from the group consisting of the (1) to (3) in a visible light range is 240 nm or less.

9. An image display apparatus, comprising the color filter according to claim 1.
